(19) United States
(12) Patent Application Publication
(10) Pub. No.: US 2021/0387347 A1
(43) Pub. Date: Dec. 16, 2021

(54) ROBOTIC ARM CAMERA

(71) Applicant: SELFIE SNAPPER, INC., SHERMAN OAKS, CA (US)

(72) Inventor: Denis KOCI, SHERMAN OAKS, CA (US)

(73) Assignee: SELFIE SNAPPER, INC., SHERMAN OAKS, CA (US)

(21) Appl. No.: 17/346,018

(22) Filed: Jun. 11, 2021

Related U.S. Application Data
(60) Provisional application No. 63/038,650, filed on Jun. 12, 2020.

(51) Int. Cl. B25J 9/16

(52) U.S. Cl. CPC B25J 9/1697; B25J 9/1664

(57) ABSTRACT

Disclosed embodiments include a robotic arm for moving one or more objects fixed to the robotic arm. The robotic arm may have a telescoping arm the extends out from and contracts into a base platform and two joints for precisely moving an attachment platform. In various embodiments, a camera is mounted to the robotic arm and a computer included in the robotic arm may execute a control path to move the camera within a scene. The robotic arm may include one or more motors for automatically moving components of the robotic arm. The robotic arm may be synchronized with a camera to perform an automated photoshoot that captures various perspectives and angles of a scene.

### RELATED APPLICATIONS

This application claims priority under 35 U.S.C. § 119(e) to U.S. provisional application No. 63/038,650 filed Jun. 12, 2020, the entirely of which is incorporated by reference. The application is related to U.S. provisional application No. 63/038,653 filed Jun. 12, 2020, the entirely of which is incorporated by reference. The application is also related to U.S. patent application Ser. No. 17/139,768 which claims priority under 35 U.S.C. §119(e) to U.S. provisional application No. 62/956,054 filed Dec. 31, 2019; U.S. provisional application No. 63/094,547 filed Oct. 21, 2020; and U.S. provisional application No. 63/115,527 filed Nov. 18, 2020, the entirely of which are incorporated by reference. The application is also related to U.S. patent application Ser. No. 16/922,979 which claims priority under 35 U.S.C. § 119(e) to U.S. provisional application No. 62/871,158 filed Jul. 7, 2019 and U.S. provisional application No. 62/956,054 filed Dec. 31, 2019, the entirely of which are incorporated by reference. The application is also related to U.S. patent application Ser. No. 16/922,983 which claims priority under 35 U.S.C. § 119(e) to U.S. provisional application No. 62/871,160 filed Jul. 7, 2019 and U.S. provisional application No. 62/956,054 filed Dec. 31, 2019, the entirely of which are incorporated by reference.

### FIELD

The present disclosure relates generally to robotics and camera systems, in particular, systems and methods for automated and dynamic scene capture.

### BACKGROUND

In the pursuit of capturing high quality visual content, elaborate camera systems including rigs, tracks, rails, gimbals, and other components have been developed. These camera systems position a camera to capture different perspectives of a subject by moving one or more cameras to various positions within a scene. Currently, camera systems are highly specialized pieces of equipment that are difficult to engineer and impossible for non-professionals to operate. Moreover, camera systems are made up of large, heavy, and expensive components that are highly customized for a particular shot and/or scene. There is therefore a need to develop a camera system for everyday use that is portable and easy to use.

Every day, people take millions of self-portrait or “selfie” photos. Many of these photos are uploaded to social media platforms and shared as posts that provide updates about the selfie subject to a network of followers. Selfie's are taken to document all aspects of people's lives from every day moments to important milestones. Accordingly, people take selfie's anywhere, at any time, and in any environment and often spontaneously while on the go. Despite the frequently spontaneous nature of the decision to take a selfie, many people are highly critical of their appearance in selfie photos and will not stop re-taking a selfie until everything looks just right. Taking a good selfie is hard and a lot of time is wasted in re-taking photos to get the pose, angle, lighting, background, and other characteristics just right. There is therefore a need to develop a camera system that captures many different perspectives of a selfie scene to reduce the number of takes required to produce a good selfie, improve the appearance and quality of selfie photos, and/or ensure everyone in a group selfie is captured.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 depicts an exemplary system for capturing and sharing image content.

FIG. 2 depicts an exemplary system for capturing and sharing video content.

FIG. 3 illustrates more details of portions of the systems shown in FIGS. 1-2.

FIG. 4 illustrates an exemplary camera device used to capture content.

FIG. 5 illustrates an exemplary robotic arm used to position a camera device.

FIGS. 6A-B illustrates an exemplary camera system having a rotating platform.

FIGS. 7A-C illustrate an exemplary camera system having a telescoping robotic arm.

FIGS. 7D-E illustrate an exemplary camera system having gimbal attached to the telescoping arm shown in FIGS. 7A-C and the rotating platform shown in FIGS. 6A-B.

FIG. 7F illustrates exemplary axes of rotation provided by the components of the robotic arm.

FIGS. 8A-C illustrate an exemplary camera attachment platform for fixing a camera device to the telescoping arm.

FIG. 9 illustrates an exemplary electroadhesion device for holding a camera system.

FIGS. 10A-C illustrate a camera mounted to a robotic arm using the electroadhesion device shown in FIG. 9.

FIG. 11 illustrates an exemplary camera system mounted to a target surface using the electroadhesion device shown in FIG. 9.

FIG. 12 is a flow diagram illustrating an exemplary process for capturing and sharing content using the system shown in FIG. 1.

FIG. 13 is a flow diagram showing an exemplary process for streaming content using the system shown in FIG. 2.

FIG. 14 is a block diagram of an illustrative user device that may be used to implement the system of FIG. 3.

FIG. 15 is a block diagram of an illustrative server device that may be used to implement the system of FIG. 3.

FIG. 16 is a block diagram of the camera device shown in FIG. 4.

FIG. 17 is a block diagram illustrating more details of portions of the camera device shown in FIG. 4.

FIG. 18 is a block diagram of the robotic arm shown in FIG. 5.

### DETAILED DESCRIPTION OF ONE OR MORE EMBODIMENTS

As used herein, the terms “camera system” and “camera systems” refer to a system having a mechanism for attaching one or more cameras and an apparatus that moves the one or more cameras. Exemplary camera systems can include components such as, motors, pivots, hinges, robotic arms, rigs, gimbals, rails, tracks, attachment platforms, wheels, rotating platforms, and the like.

As used herein, the terms “user device” and “user devices” refer to any computer device having a processor, memory, and a display. Exemplary user devices can include a communications component for connecting to a camera and/or a camera system and may include smartphones, tablet computers, laptops, mobile computers, hand held computers, personal computers, and the like.

As used herein the terms “piece of content” and “pieces of content” refer to images, video, and other content capable of capture by a camera of the disclosure. Selfie images are exemplary pieces of content. Pieces of content may be transferred as data files including image data, audiovisual data, and the like using file/data lossless transfer protocols such as HTTP, HTTPS or FTP.

As used herein, the terms “selfie image” and “selfie images” refer to images and videos of a person taken by that person. Portrait and/or self-portrait type images of objects (e.g., food, clothing, tools, jewelry, vehicles, memorabilia, personal items, and the like) and/or groups of people are also included in the terms “selfie image” and “selfie images” as disclosed herein.

As used herein, the terms “share”, “shared”, and “sharing” refer to the digital distribution of content including images, recorded video, and live video. Content may be shared using a user device (e.g., personal computer, laptop, camera, smart phone, tablet, etc.) directly to another user device. Additionally, content may be shared with an online community (e.g., social media network, public online audience, group of online friends, etc.) by uploading to a host website or posting to a social media platform.

As used herein, the terms “subject” and “subjects” refer to the people, objects, landscapes, background elements, and any other aspects of a scene that may be captured in a photo or video. Human subjects may include a single person, multiple people, a group of people, multiple groups of people, and/or one or more crowds of people. Object subjects may include one or more pets, items and/or plates of food, one or more items of clothing, and/or any number of things or other objects.

### Exemplary Embodiments of the System

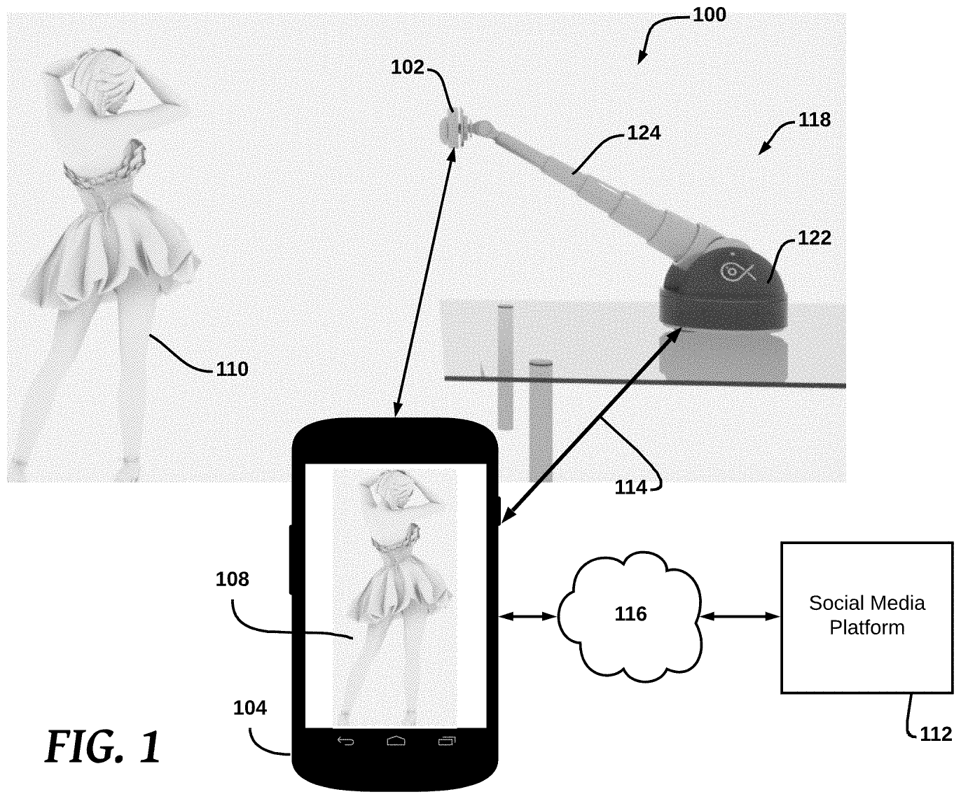

FIG. 1 illustrates an example embodiment of an imaging system 100 that may capture and share pieces of content including selfie images. The imaging system 100 may include a camera 102 that captures pieces of content including, for example, video and images of a subject 110. The camera 102 and or robotic arm 118 may be communicatively coupled to a user device 104 and/or any other remote computer using one or more connections 114 (e.g., a Bluetooth, Wifi, or other wireless or wired connection). In various embodiments, the camera 102 may be fixed to a robotic arm 118 having a rotating platform. The robotic arm 118 may move the camera 102 within a scene to capture different perspectives of the subject 110.

The camera 102 may stream a preview 108 of the area within the field of the view of the camera 102 to a user device 104. Using the user device 104 as a remote control, a user may move the camera 102 via the robotic arm 118 and capture content using the camera 102 by remotely activating the camera 102 using the user device 104. In various embodiments, the preview 108 may include a live preview (e.g., a pre-capture live video preview) showing the subject 110 and surrounding area captured by the image sensor of the camera 102. The preview 108 may also include a post-capture preview showing a static and or dynamic image captured by the camera 102 and before any editing or other post processing. The preview 108 may be an uncompressed, full resolution view of the image data captured by the camera 102 and/or the preview 108 may be a compressed version of the image data captured by the camera 102. Before deciding to initiate capture, a user may view the pre-capture preview to assist the capture process by verifying the camera 102 is in the correct position and the subject 110 appears as the user would like. When the subject 110 appears as the user would like in the pre-capture preview, the user may capture content displayed in the preview using the camera 102. The post-capture preview of the captured content is then sent by the camera 102 to the user device 104 and displayed on a user device display. If the user is happy with how the content turned out, the user may share the content, for example, a selfie image to a social media platform 112. If the user desires to take another photo of the subject 110 or capture more content, the first piece of content may be saved on the user device or discarded and the preview 108 changed from a post-capture preview back to pre-capture preview including a live video of the subject 110 and surrounding area.

The user device 104 may be a processor based device with memory, a display, and wired or wireless connectivity circuits that allow the user device 104 to communicate with the camera 102, the robotic arm 118, and/or the social media platform 112 and interact/exchange data with the camera 102, the robotic arm 118, and/or the social media platform 112. For example, the user device 104 may communicate a message to the robotic arm 118 to move the camera 102, for example, to a position in front of the subject 110. In response to sending a message to control the robotic arm 118, the user device 104 may receive a confirmation from the robotic arm 118 that control command has been executed and/or the camera 102 has been moved to the specified position. The user device 104 may then communicate a message to the camera 102 to capture an image and receive an image file including image data in response from the camera 102. The image file may be displayed on a user device display as a preview 108.

The user device 104 may be a smartphone device, such as an Apple iPhone product or an Android OS based system, a personal computer, a laptop computer, a tablet computer, a terminal device, and the like. The user device 104 may have an application (e.g., a web app, mobile app, or other piece of software) that is executed by the processor of the user device 104 that may display visual information to a user including the preview 108 before and/or after image capture and a user interface (UI) for editing and/or sharing content. The communications path 116 may include one or more wired or wireless networks/systems that allow the user device 104 to communicate with a social media platform 112 using a known data and transfer protocol. The social media platform 112 may be any known social media application including Twitter, Facebook, Snapchat, Instagram, Wechat, Line, and the like.

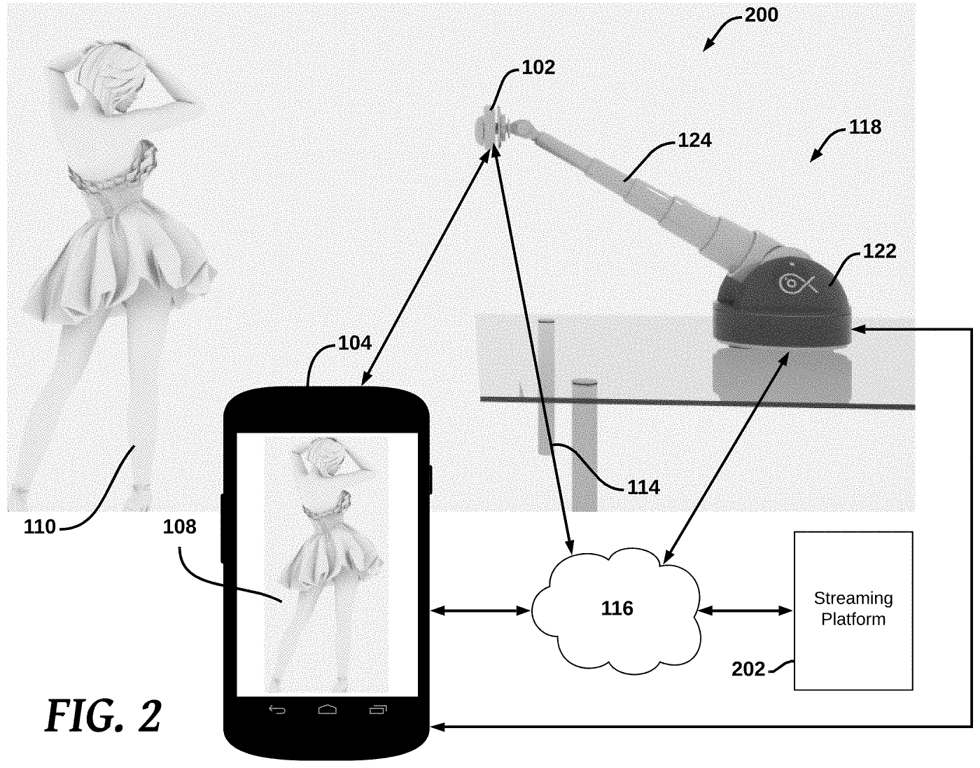

FIG. 2 illustrates an example embodiment of a streaming 200 system that may capture, share, and stream content including videos. The streaming 200 system may include the camera 102 that captures pieces of content including, for example, video and images of a subject 110. The camera 102 may be communicatively coupled to the user device 104 using one or more connections 114 (e.g., a Bluetooth, Wifi, or other wireless or wired connection). In various embodiments, the camera 102 may be fixed to the robotic arm 118 having a rotating platform. The robotic arm 118 may move the camera 102 within a scene to capture different perspectives of the subject 110.

To stream content, the camera 102 connects to the user device 104 using one or more connections 114 (e.g., a Bluetooth, Wifi, or other wireless or wired connection). Once connected to the camera 102, the user device 104 may receive a preview 108 (e.g., pre-capture live video preview) of the subject 110 from the camera 102 and display the preview 108 on a user device display. The preview 108 may show the subject 110 and the area surrounding the subject 110 as captured by the image sensor in the camera 102. The content displayed in the preview 108 may be adjusted by changing the position of the camera via the robotic arm 118. Once the subject 110 appears as desired in the preview 108, video captured by the camera 102 may be streamed to a video streaming platform 202. Remote control functionality included in an application (e.g., mobile app, web app, or other piece of software) executed by the processor of the user device 104, may cause the robotic arm 118 to change the position of the camera 102 and/or cause the camera 102 to record and share content including videos on a streaming platform 202. To share a video or other piece of content on a streaming platform 202, the camera 102 may connect to the streaming platform 202 using a communications path 116. User account information, including account name and login information, may be received from the user device 104 as part of the connection process. The user device 104 connected to the camera 102 and/or robotic arm 118 may simultaneously connect to the steaming platform 202 using the communications path 116. The communications path 116 connecting the user device 104 and the streaming platform 202 and the camera 102 and the streaming platform 202 gives users full control over the user device 104 when live streaming video (i.e., “going live”) to the streaming platform 202 because, in the streaming 200 system, the camera 102 may stream content to the streaming platform 202 instead of the user device 104. Therefore, functionality of the user device 104 (e.g., the ability to access the social media platform 112, control the robotic arm 118, preview captured content, and the like) is not inhibited when a user live streams video and other content to the streaming platform 202 using the streaming 200 system.

The user device 104 may communicate with the camera 102, robotic arm 118, and/or video streaming platform 202 and interact/exchange data with the camera 102, robotic arm 118, and/or the video streaming platform 202. For example, the user device 104 may communicate one or more messages to the robotic arm 118 to change the position of the camera 102. In response, the robotic arm 118 may send a message (e.g., a push notification) confirming the new position of the camera 102. The user device 104 may communicate one or more messages to the camera 102 to record video and/or stream video to the streaming platform 202. In response, the camera 102 may send a message (e.g., a push notification) to the user device 104 indicating a live video stream has started. The user device 104 connected to the streaming platform 202 will then be able to view the live video stream provided by the camera 102 on a user device display.

In various embodiments, the user device 104 may have an application (e.g., a web app or a mobile app) that is executed by the processor of the user device 104 that may display visual information to a user including a preview 108 before and/or after recording content and a user interface for streaming, editing, and/or sharing content. The communications path 116 may include one or more wired or wireless networks/systems that allow the user device 104, robotic arm 118, and/or the camera 102 to communicate with a streaming platform 202 using a known data and transfer protocol. The streaming platform 202 may include one or more video streaming servers for receiving content from the camera 102 and a plurality of video streaming clients for distributing content from the video streaming server. To facilitate sharing live video content, one or more communications paths 116 and/or streaming platforms 202 may include a content distribution network for distributing video content from one or more video streaming servers to a plurality of video streaming clients. The streaming platform 202 may be any known content streaming application including Twitch, TikTok, Houseparty, Youtube, Facebook, Snapchat, Instagram, Wechat, Line, and the like.

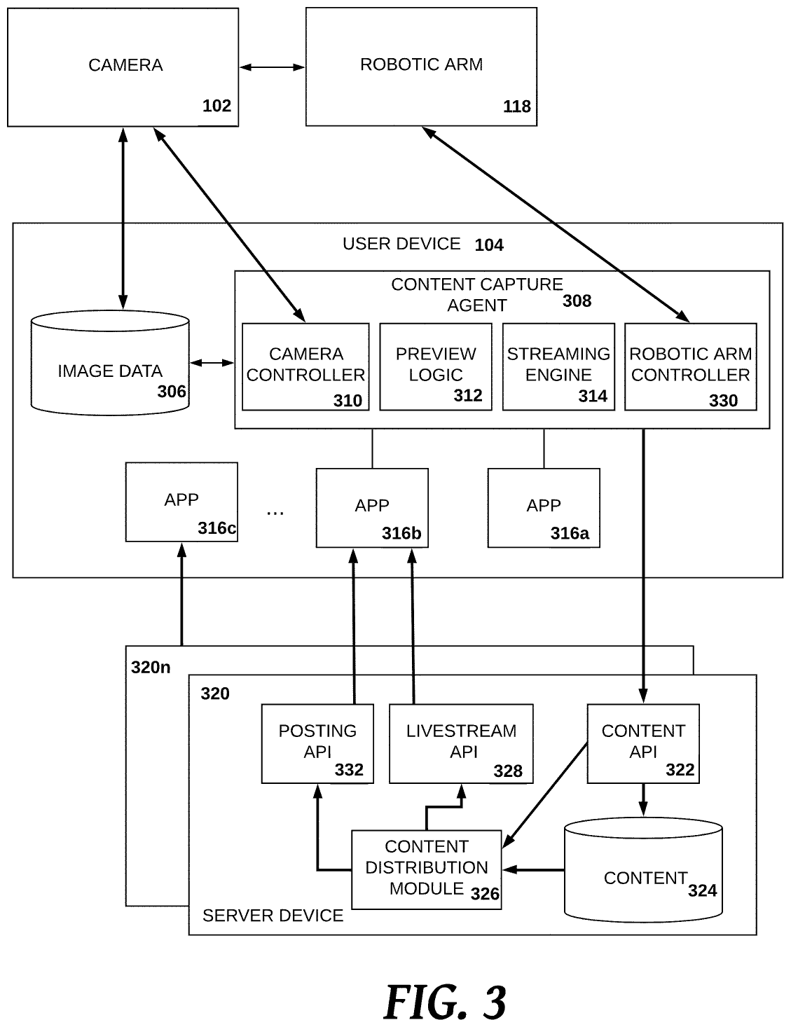

FIG. 3 illustrates more details of the systems shown in FIGS. 1-2 and specifically more details of the user device 104 and a server device 320 that may be incorporated into at least one of the social media platform 112 and/or the streaming platform 202. The components shown in FIG. 3 provide the functionality delivered by the hardware devices shown in FIGS. 1-2. As used herein, the term “component” may be understood to refer to computer executable software, firmware, hardware, and/or various combinations thereof. It is noted that where a component is a software and/or firmware component, the component is configured to affect the hardware elements of an associated system It is further noted that the components shown and described herein are intended as examples. The components may be combined, integrated, separated, or duplicated to support various applications. Also, a function described herein as being performed at a particular component may be performed at one or more other components and by one or more other devices instead of or in addition to the function performed at the particular component. Further, the components may be implemented across multiple devices or other components local or remote to one another. Additionally, the components may be moved from one device and added to another device or may be included in both devices.

As shown in FIG. 3, the user device 104 may be communicatively coupled to the camera 102 and specifically receive image data (e.g., content including images and videos) and send and receive messages. Image data received from the camera 102 may be stored in an image data store 306 included in any device (e.g., the user device 104, a remote server, and the like). The image data store 306 may store image data in various ways including, for example, as a flat file, indexed file, hierarchical database. relational database, unstructured database, graph database, object database, and/or any other storage mechanism. The image data store 306 may be implemented as a portion of the user device 104 hard drive or flash memory (e.g., NAND flash memory in the form of eMMCs, universal flash storage (UFS), SSDs etc.). To capture and process content, the user device 104 may include a content capture agent 308. In various embodiments, the content capture agent 308 may be implemented as a piece of software including a stand-alone mobile app installed on the user device, a stand-alone web app accessible by an web browser application, and/or as a plug-in or other extension of another mobile app installed on a user device (e.g., a naïve camera app, photo app, photo editing app, etc.) or web app accessible through a web browser. The content capture agent 308 may be communicatively coupled to the camera 102, the robotic arm 118, and a plurality of other apps (316a, 316b, 316c, etc.) that are executed by a processor of the user device 104.

To control the position of the camera 102 via the robotic arm 118, the content capture agent 308 may include a robotic arm controller 330. The robotic arm controller 330 may allow the user device 104 to function as a remote control for controlling the robotic arm 118. In various embodiments, the robotic arm controller 330 may include a user interface, for example a graphical user interface (GUI) for controlling the robotic arm 118. The robotic arm control GUI may be displayed on the user device display and may include one or more components (e.g., buttons, sliders, directional pads, wheels, and the like) that may be manipulated by a user to communicate controls to the robotic arm. In various embodiments, the robotic arm controller 330 may also include one or more control paths for moving the robotic arm within a scene.

When executed by the robotic arm controller 330, the control paths may move the robotic arm 118 to a series of positions that capture a different perspectives and/or portions of a scene. For example, a pre-determined control path may include a photoshoot control path that moves the camera to a series of capture positions around a subject and captures portraits and/or “selfies” of the subject from many different angles and perspectives. In various embodiments, the positions included in the photoshoot control path may be based on and/or identical to capture positions used during photoshoots by professional photographers. Positions included in one or more photoshoot control paths may be determined manually and/or learned from the position of cameras and/or photographers during actual photoshoots using machine learning techniques. Determining camera positions to include in photoshoot control paths from actual photoshoots allows the robotic arm controller 330 to capture angles and perspectives of a subject that are identical to the angles and perspectives captured in a professional photoshoot.

In various embodiments, to facilitate content capture, a user may select a control path for the robotic arm from the robotic arm control GUI, the robotic arm controller 330 may perform an automated capture sequence by executing a control path (e.g., a photoshoot control path) to move the camera 102 to a series positions included in the camera control path. At each position, the user may preview the image on the user device 104 and decide to capture content by remotely activating the camera 102 using the user device 104 or move to the next position. In various embodiments, the camera 102 may be programed to capture one or more pieces of content at each position and, at the conclusion on the automated capture sequence, transmit the captured pieces of content to the user device for previewing and/or post processing by the user.

In various embodiments, the control path executed by the robotic arm controller 330 to move the robotic arm 118 may be specific to one or more characteristics of a scene, for example, scene dimensions, lighting, subject type, and the like. Before executing the control path, the robotic arm controller 330 may customize a control path to one or more characteristics of a scene using an automated control path set up process. To begin the automated control path set up, the robotic arm controller 330 determines scene characteristics using one or more sensors. For example, the robotic arm controller 330 may take a series of photos of the scene using the camera 102 and determine the scene dimensions, lighting, subject type, and other characteristics from the series of photos. The robotic arm controller 330 may then customize the control path selected by the user based on the scene characteristics.

In various embodiments, the content capture agent 308 may also include a camera controller 310, preview logic 312, and a streaming engine 314. The camera controller 310 may send and receive messages and other data from the camera 102 to control camera functionality. For example, the camera controller 310 may receive a message from the camera 102 indicating when camera 102 is powered on and located close enough to the user device 104 to establish a connection. In response, the camera controller 310 may send a message containing a connection request to establish a communication path with the camera 102. The camera controller 310 may send messages including commands for adjusting one or more camera settings (e.g., zoom, flash, aperture, aspect ratio, contrast, etc.) of the camera 102. The camera controller 310 may send messages including commands causing the camera 102. to capture and/or share content, for example, record video, stream video, capture images, and the like.

The camera controller 310 may interface with the robotic arm controller to synchronize content capture performed by the camera 102. with movements performed by the robotic arm 118. In various embodiments, a control path may include commands to operate the camera 102 at specific times and/or positions during the execution of the control path. For example, at each capture position included in the control path, the robotic arm controller 330 may send a capture command to the camera controller 310 to cause the camera 102 to capture one or more pieces of content at each capture position. To synchronize the movements of the robotic arm 118, with the camera 102, the robotic arm controller 330 may send a message to the camera controller 310 confirming that the robotic arm controller 330 has moved the camera to a capture position. Upon receiving the confirmation from the robotic arm controller 330, the camera controller 310 may initiate content capture (e.g., taking a picture, recording a video, and the like) by the camera 102. In various embodiments, the robotic arm controller 330 may communicate directly with the camera 102 to facilitate synchronization between the robotic arm 118 and the camera 102.

In various embodiments, the camera 102 executes the commands provided by the camera controller 310 and/or robotic arm controller 330 and then distributes captured content to the image data store 306. In various embodiments, the camera controller 310 may execute one or more capture routines for controlling content captured by the camera 102. Capture routines may be performed as a part of a control path of the robotic arm 118 (e.g., at each capture position) or independent of the robotic arm 118 and/or robotic arm controller 330. In various embodiments, a capture routine may cause the camera 102 and/or user device 104 to provide a visual or auditory countdown signaling when capture is about to take place. For example, a capture routine may include a three to 10 second countdown that incorporates displaying a countdown sequence of numbers (one number per second) on a user device display. The countdown may also include an audio component that audibly counts backward from, for example, 10 to 1. The audio component may be in sync with the user device display so that when the number displayed on the user device display the number is counted in the audio component. At the conclusion of the countdown, the camera controller 310 may initiate content capture. One or more delays can be included in the capture routine to provide additional time to between completing the countdown and initiating content capture. Capture routines executed by the camera controller 310 may capture a sequence of, for example 2 to 5, photos with each captured photo displayed in a preview shown on the user device display.

In various embodiments, when executing a command to stream video, the camera 102 may initiate a connection with the server device 320 (e.g., a streaming platform server) of a streaming platform. Once connected with the server device 320, the camera 102 may stream videos and other content to the server device 320 for distribution to a plurality of streaming platform clients. In various embodiments, the camera 102 may also provide video and other content for streaming to the image data store 306. The streaming engine 314 may retrieve video and other content for streaming from the image data store 306 and transfer the video for streaming to a content API 322. using file/data lossless transfer protocols such as HTTP, HTTPS or FTP. Video and other content for streaming may then be provided to a content distribution module 326 for distribution to a plurality of clients through a livestream API 328 and/or stored in a content database 324. In various embodiments the content distribution module 326 and/or the livestream API 328 may include a media codec (e.g., audio and/or video codec) having functionality for encoding video and audio received from the camera 102 and or user device 104 into a format for streaming (e.g., an audio coding format including MP3, Vorbis, AAC, Opus, and the like and/or a video coding format including H.264, HEVC, VP8 or VP9) using a known streaming protocol (e.g., real time streaming protocol (RTSP), real-time transport protocol (RTP), real-time transport control protocol (RTCP), and the like). The content distribution module 326 and/or livestream API 328 may then assemble encoded video streams in a container bitstream (e.g., MP4, WebM, ASF, ISMA, and the like) that is provided by the livestream API 328 to a plurality of streaming clients using a known transport protocol (e.g., RTP, RTMP, HLS by Apple. Smooth Streaming by Microsoft, MPEG-DASH by Adobe, and the like) that supports adaptive bitrate streaming over HTTP or other known web data transfer protocol.

The content capture agent 308 may connect to one or more mobile or web apps 316b, 316a executed by a processor of the user device. In various embodiments, preview logic 312 may parse GUIs included in a mobile app and or web app to capture the size and resolution of images displayed in social media posts and/or video streamed on a streaming platform. For example, preview logic 312 may parse HTML, CSS, XML, JavaScript, and the like elements rendered as web app GUIs to extract properties (e.g., size, resolution, aspect ratio, and the like) of images and/or videos displayed in web app implementations of social media platforms and/or video streaming platforms. Preview logic 312 may extract properties of images and/or video displayed in mobile app implementations of social media platforms and/or video streaming platforms by parsing Swift, Objective C, and the like elements (for iOS apps) and/or Java, C, C++, and the like elements (for Android apps). To create a realistic preview of how an image or livestream video will look on a social media platform and/or video streaming platform, preview logic 312 may include instructions for modifying images received from the camera 102 to mirror the characteristics of image and video content displayed on one or more platforms. For example, preview logic 312 may crop content to a size and/or aspect ratio that matches the size and/or aspect ratio of a particular GUI (e.g., post GUI, content feed GUI, live stream GUI, and the like) included in a web app and/or mobile app implementation of a social media and/or video streaming platform. Preview logic 312 may also change the resolution of content received from the camera 102 to match the resolution of content displayed in a particular GUI included in a web app and/or mobile app implementation of a social media and/or video streaming platform.

Preview logic 312 can include functionality for configuring previews projected on the user device display to match the orientation of the user device display. For example, preview logic 312 may access a motion sensor (e.g., gyroscope, accelerometer, and the like) included in the user device 104 to determine the orientation of a user device display. Preview logic 312 may then crop the preview video feed and/or captured content received from the camera to fit the aspect ratio of the user device display at its current orientation. Preview logic 312 may dynamically crop the previews and/or captured content from the camera device to match the orientation of the user device display to dynamically change the aspect ratio of the previews and/or captured content, for example, from portrait to landscape when the user device display rotates from a portrait orientation to a landscape orientation.

Post capture, preview logic 312 may display content as full view content with no cropping, portrait content cropped to a portrait aspect ratio, landscape content cropped to a landscape aspect ratio, and shared content cropped to match one or more GUIs for sharing content included in a social media and/or video streaming platform. In various embodiments, preview logic 312 may incorporate one or more characteristics of content extracted from a social media and/or video streaming platform into portrait and/or landscape content. For example, preview logic 312 may modify portrait content to simulate cropping that occurs when sharing content on a content streaming GUI (e.g., Snapchat snaps, Instagram stories, Facebook stories, and the like) included in a social media and/or content streaming platform. Preview logic 312 may modify landscape content to simulate cropping that occurs when sharing wide angle content (e.g., a group photo/video captured in a landscape orientation) to a social media and/or video streaming platform. Full view content and video and image content modified by preview logic 312 into portrait content and wide-angle content may be saved to the image data store 306 and/or provided to a content API 322 of a server device 320 using as file/data lossless transfer protocols such as HTTP, HTTPS or FTP. Content received by the content API 322 may be shared to a social media and/or video streaming platform through a posting API 332.

In various embodiments, preview logic 312 may include one or more routines for editing previews and captured content. Preview logic 312 may edit captured video by segmenting recorded video into clips (i.e., 1 to 30 second segments). One or more routines for editing video clips may also be included in preview logic 312. In various embodiments, preview logic 312 may edit video clips using one or more video editing filters. For example, preview logic 312 can include editing filters that pan within a scene in any direction (e.g., horizontal, vertical, diagonal, and the like); zoom in to and/or zoom out from one more areas of a scene; show movement within a scene in slow motion; and sync one or more audio clips with playback of a video clip. Preview logic 312 may combine one or more editing filters to enable more advanced editing functionality. For example, preview logic 312 may combine a slow-motion editing filter with an audio sync editing filter to sync one or more audio clips with playback of a video clip having a slow-motion effect to mask the ambient sound distortion that may occur when a slow-motion editing filter is applied to a video clip having audio. In various embodiments, preview logic 312 may apply one or more editing filters post capture by first defining a portion of a scene included in a captured video to manipulate with an editing filter. For example, the preview logic 312 may first define a rectangle at the center of the captured video. One or more editing filters may then be applied to manipulate the aspects of a scene within the rectangle (e.g., zoom in on an object within the rectangle, pan from left to right across the objects within the rectangle, and the like). In various embodiments, preview logic 312 may apply one or more stabilization and sharpening functions to livestream video, recorded video, and recorded video clips. For example, a stabilization function may smooth out vibrations and other undesired movement included in recorded scenes and a sharpening function may reduce blurring of moving objects captured in record scenes. In various embodiments, preview logic 312 can include one or more background filters that may be applied to change the background of previews or captured content. To change the background of an image or video to one or more background filters, preview logic 312 may include instructions for segmenting the background and foreground aspects of a preview and/or captured image/video scene. The background elements of captured content and/or live video previews may then by extracted and replaced with one or more background filters. Background filters may be actual photographs to simulate real like settings and/or virtual scenes simulated virtual reality or mixed reality environments. Content modified according to one or more editing functionality of the preview logic 312 may be saved in the image data store 306 and/or provided to the content API 322 of a server device using a file/data lossless transfer protocol such as HTTP, HTTPS or FTP. Content received by the content API 322 may be shared to a social media and/or content streaming platform through the posting API 332.

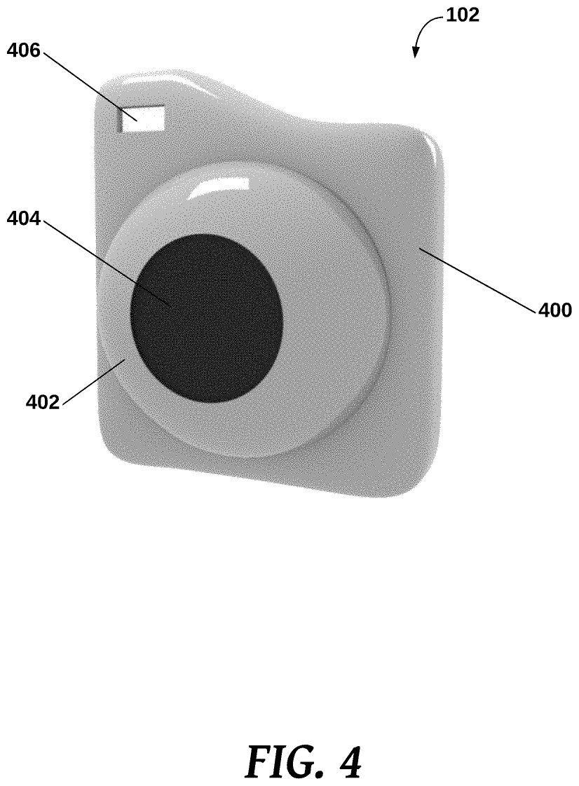

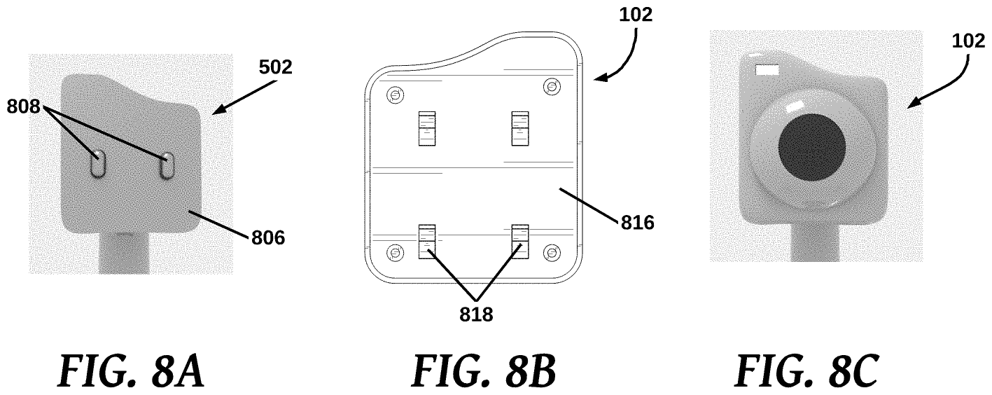

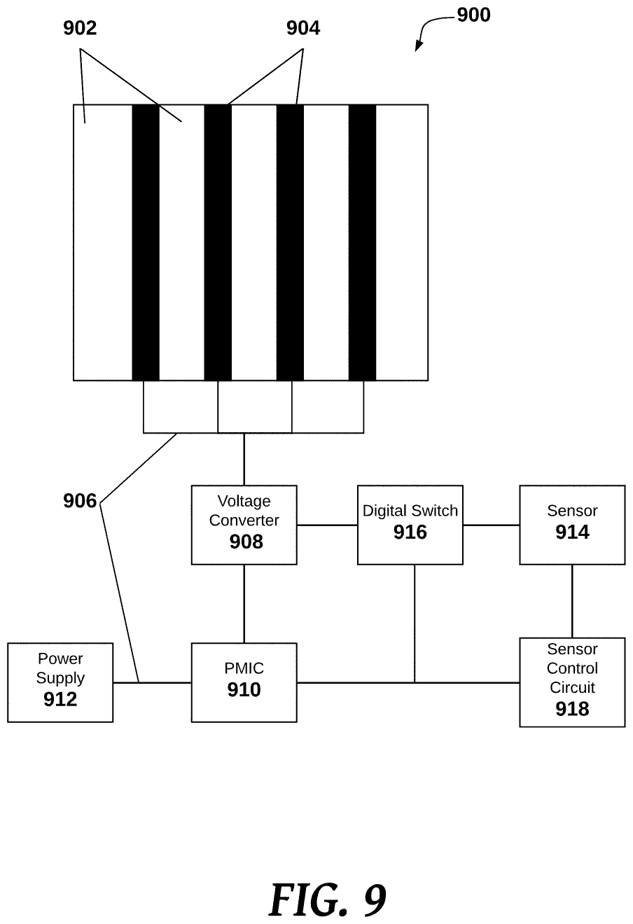

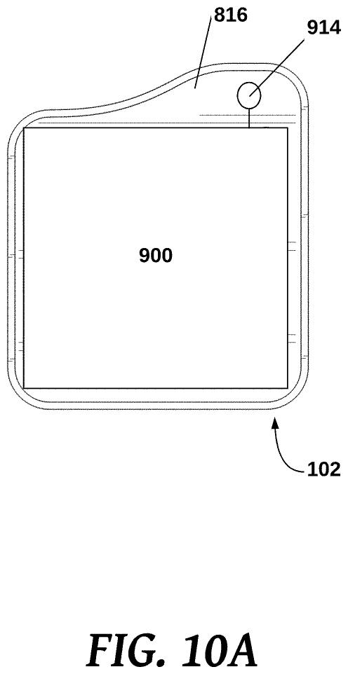

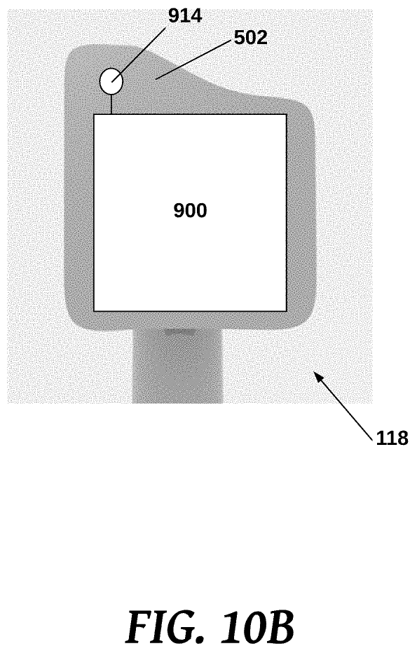

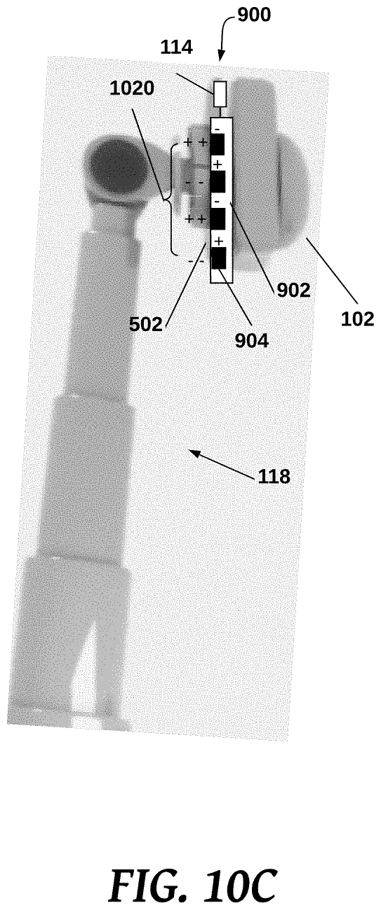

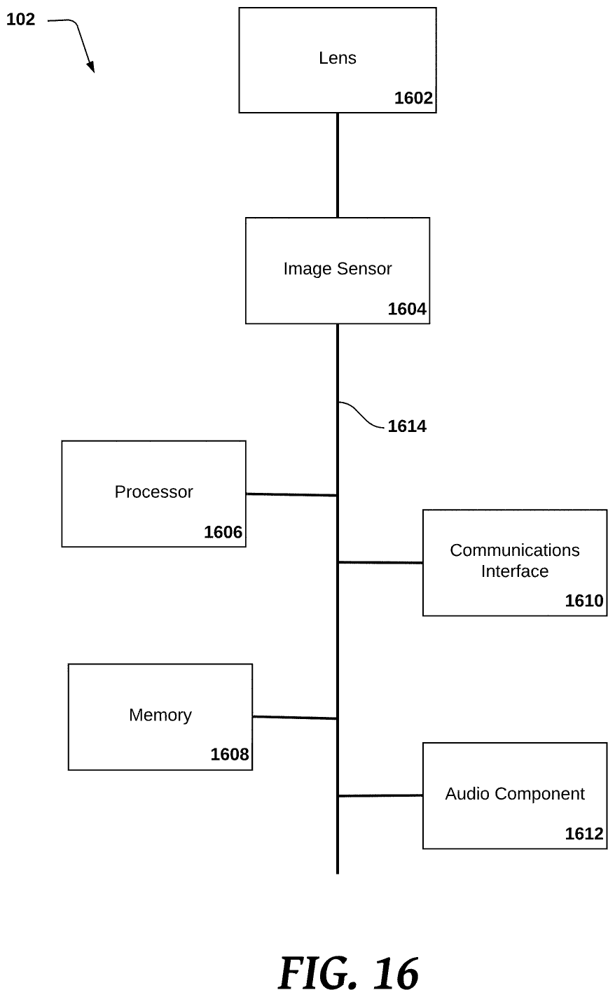

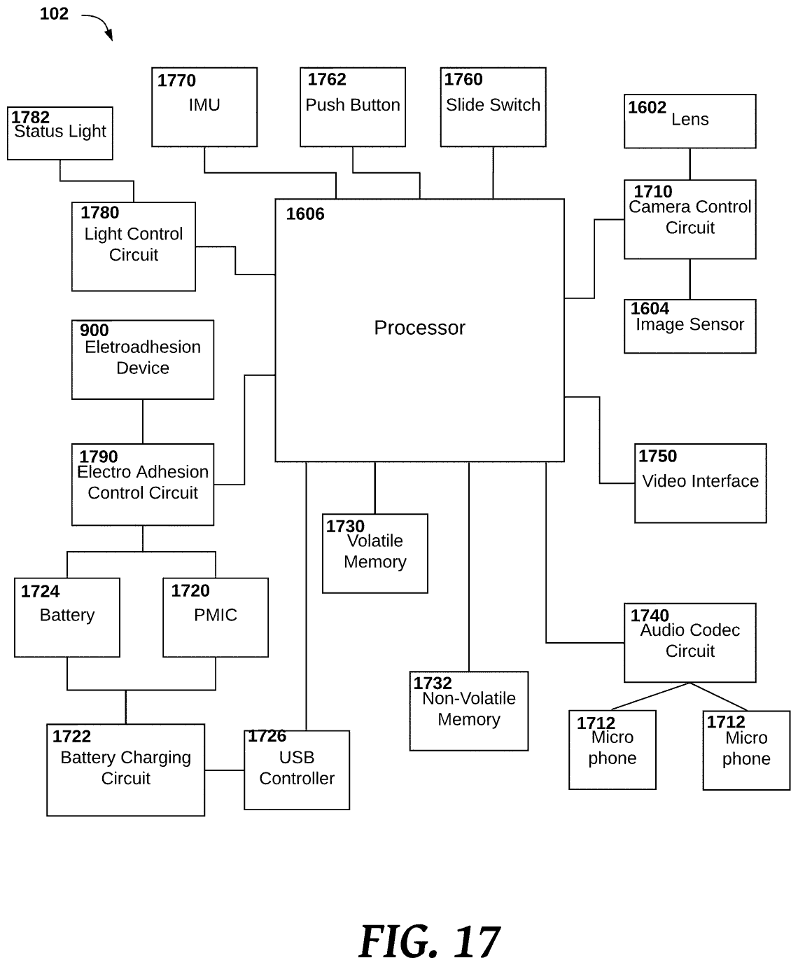

FIG. 4 illustrates one example embodiment of the camera 102. The camera 102 may include a camera body that includes a housing 400 that encloses a circuit board including the electrical components (e.g., processor, control circuits, power source, image sensor, and the like) of the camera 102. The housing 400 may include an eye portion 402 extending laterally out from the surface of the housing. The eye portion 402 may include one or more camera components (e.g., lens, image sensor, and the like). A distal end of the eye portion 402 includes an opening 404 to allow light to pass through the lens and reach the image sensor disposed inside the housing 400 and/or eye portion 402. An LED light 406 may be embedded in an exterior surface of the housing 400 to provide additional light (i.e., flash) to enable content capture in low light conditions. More details about the components of the camera 102 are described below in FIGS. 16-17. One or more mounting systems may be attached to the backside of the housing 400 opposite the eye portion 402. The mounting systems may fix the camera 102 to one or more foreign surfaces, for example, the camera attachment platform of the robotic arm 118, to position the camera 102 for capturing content. Mounting systems of the camera 102 may be compatible with an attachment mechanism of the robotic arm 188 to secure the camera 102 to the robotic arm 118. An exemplary robotic arm attachment mechanism is described below in FIGS. 8A-8C. In addition to mechanical attachment mechanisms, an electroadhesion attachment mechanism may be formed on the back of the camera 102. FIGS. 9-10B below describe an exemplary camera electroadhesion attachment mechanism of the disclosure.

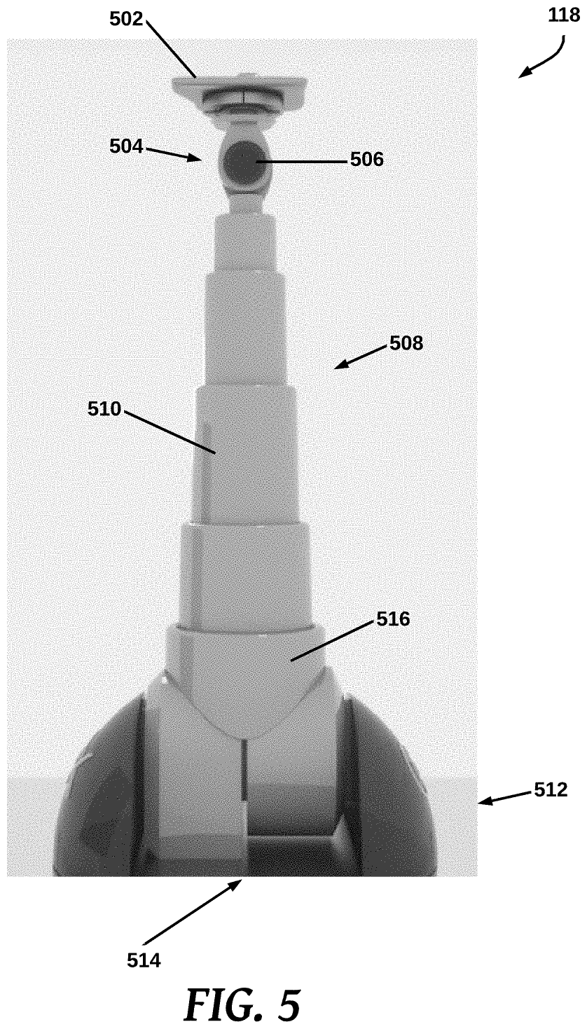

FIG. 5 illustrates an exemplary embodiment of the robotic arm 118. In various embodiments, the robotic arm 118 includes an arm portion 508 connected to a base platform 512 and a camera attachment platform 502. To increase the range of motion of the robotic arm 118, a bottom section of the arm portion 508 may attach to the base platform 512 at a lower joint 514 and the upper section of the arm portion 508 may attach to the camera attachment platform 502 at an upper joint 504. The robotic arm 118 may be a telescoping arm having one or more sections 510 (e.g., telescoping sections) that may slide out from a base section to lengthen the robotic arm 118. The telescoping arm may be made of a lightweight material such as aluminum and or carbon fiber to reduce the weight of the robotic arm 118. To further decrease the weight of the robotic arm 118, the one or more sections 510 of the telescoping arm may be hollow on the inside and or have a thin walled construction so that each section can be stored inside of an adjacent section when the arm is not extended. To extend the length of the arm, the sections 510 may extend out from a base section 516 fixed to the base platform 512 in the desired direction. To shorten the length of the arm, the sections 510 may contract into each other and ultimately into the base section 516. The base section 516 may be positioned at a proximal end of the arm portion 508 opposite the camera attachment platform 502 positioned at a distal end of the arm portion 508.

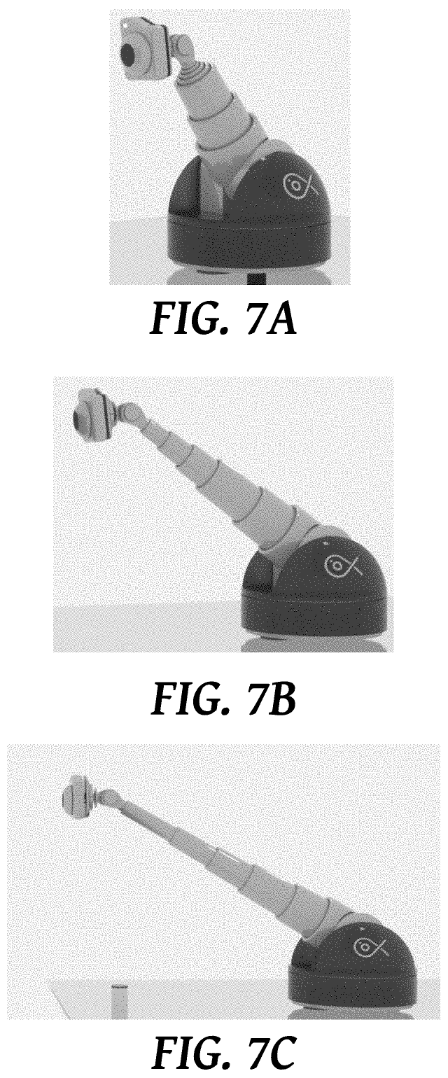

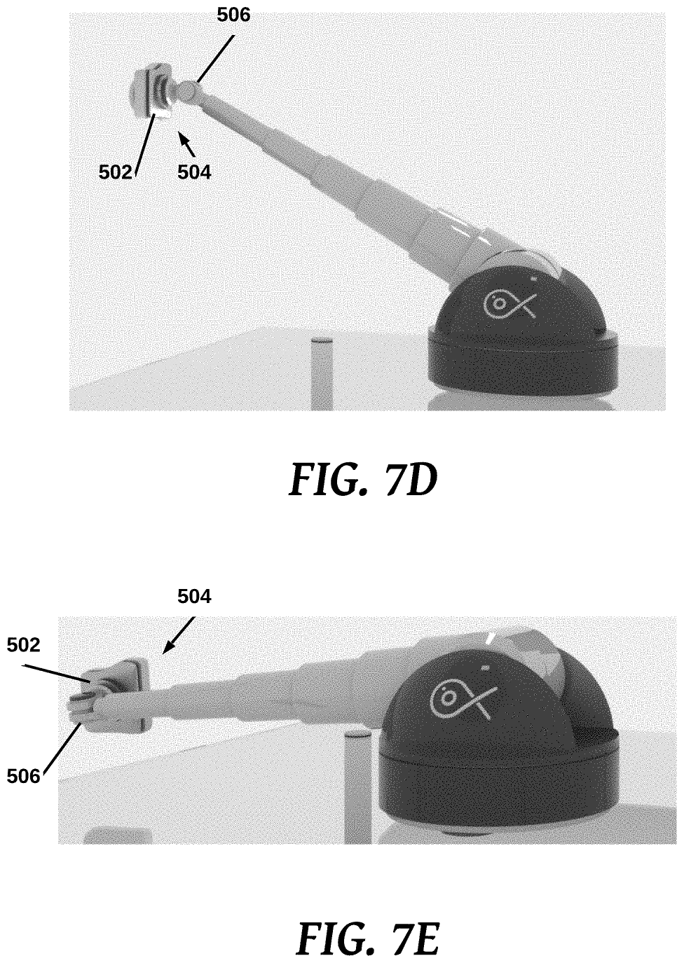

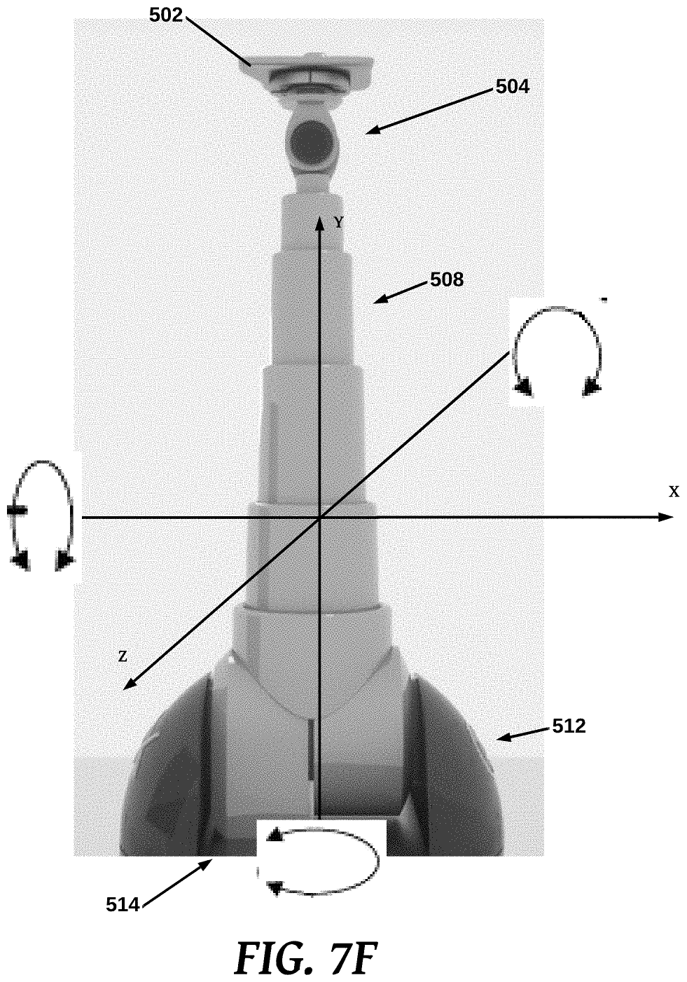

FIGS. 7A-C below illustrate lengthened and shortened positions of the telescoping arm. The base platform 512 may be a rotating platform and/or include a rotating section that can rotate up to 360° along a first axis of rotation to adjust the direction of the arm portion 508. In various embodiments, the first axis of rotation may be a vertical axis that extends vertically up from the base platform and is perpendicular to the ground. Therefore, the base platform 512 may include a rotating section that can rotate the arm portion 508 up to 360° relative to the vertical axis of ration that extends longitudinally up from the base platform 512.

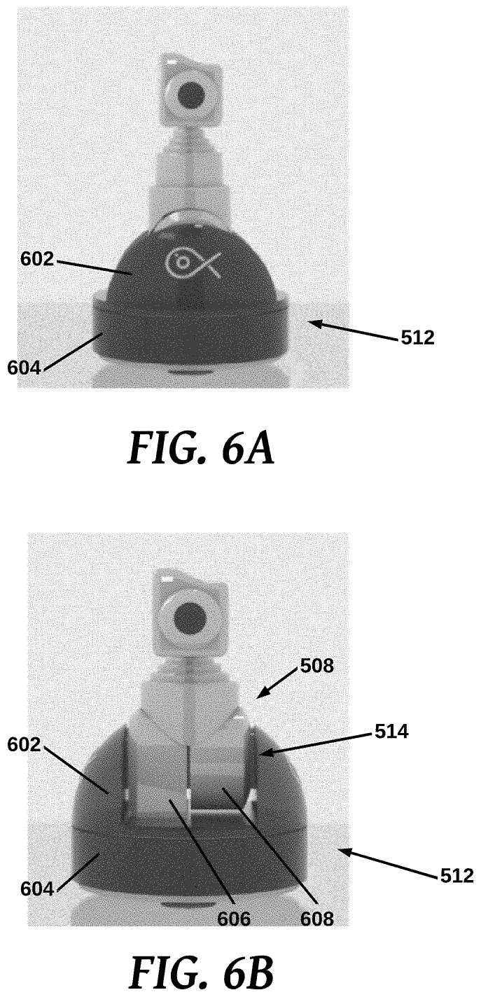

FIGS. 6A-B below illustrate an exemplary embodiment of the base platform 512 in more detail. The camera attachment platform 502 may secure any camera (e.g., the camera 102) to the robotic arm 118. Various mechanical and electroadhesion attachment mechanisms may be used to fix the camera 102 to the camera attachment platform 502. FIGS. 8A-8C illustrate an exemplary mechanical attachment mechanism and FIGS. 9-10C illustrate an exemplary electroadhesion attachment mechanism.

In various embodiments, the upper joint 504 may include a gimbal 506 having a 180° pivot for changing the position of a camera secured to the robotic arm via the camera attachment platform 502. The gimbal may be compatible with any camera including, for example, the camera 102. The gimbal 506 may stabilize the camera 102 as the camera 102 is moved by the robotic arm 118 to allow the camera 102 to capture content while in motion. In various embodiments, the gimbal 506 may be a pivoted support that allows the rotation of the camera 102 about a single axis. The gimbal 506 may be a mechanical and/or motorized three axis gimbal that includes a set of three gimbals, one mounted on the other with orthogonal pivot axis, with the camera 102 mounted on the inter-most gimbal. In this arrangement, the camera 102 remains independent of the rotation of the supporting gimbals, therefore, may remain stable and in the same position despite the rotation of the supporting gimbals. Accordingly, the gimbal 506 may stabilize the camera 102 and/or smooth the content captured by the camera 102 while the robotic arm 118 is moving by isolating the movement and vibration of the camera 102 from the movement of the robotic arm 118.

In various embodiments, the lower joint 514 may include a left and right pivot. The left and right pivots may be activated mechanically or by a motor to move the robotic arm up to 90° from center. For example, the left pivot may be used to rotate the robotic arm up to 90° to the left of center and the right pivot may be used to rotate the robotic arm up to 90° to the right of center. In total, the left and right pivots may move the robotic arm up to 180° degrees from center (i.e., up to 180° relative to a horizontal axis of rotation extending horizontally out from the base platform 512). The upper joint 504 and the lower joint 514 may form two 180° axes for adjusting the position of robotic arm 118 and changing the perspective captured by the camera 102 attached to the robotic arm 118. The base platform 512 may increase the range of motion of the robotic arm 118 by providing a third 360° axis for adjusting the position of the robotic arm 118 and/or perspective capture by the attached camera 102. In various embodiments, the lower joint 514 may rotate the robotic arm 118 along an axis of rotation that is perpendicular to the axis of rotation of the base platform 512. The upper joint 504 may rotate the camera attachment platform 502 up to 180° about a third axis of rotation that may be perpendicular to one or more of the axes of rotation provided by the lower joint 514 and the base platform 512. For example, the upper joint may rotate the camera attachment platform 502 up to 180° relative to a vertical axis of rotation that extends longitudinally up from the base platform 512. FIG. 7F illustrates exemplary axes of rotation provided by the components of the robotic arm.

FIGS. 6A-B illustrate the lower joint 514 and base platform 512 in more detail. FIG. 6A illustrates the robotic arm in a closed position with the opening exposing the right and lifts pivots 606, 608 of the lower joint 514 hidden from view. FIG. 6B illustrates the robotic arm in an open position with the right and left pivots 606, 608 visible. The base platform 512 may include a bottom section 604 and a top section 602. In various embodiments, the top section 602 may be attached to the bottom section 604 using a rotating hinge or joint that allows the top section 602 to rotate on top of the bottom section 604 which remains stable. To rotate the top section 602, the base platform 512 may include a motor. In various embodiments, the motor may be controlled by the robotic arm controller and may be disposed inside the base platform. The top section 602 may attach to the bottom section of the arm portion 508 by attaching to the lower joint 514. In various embodiments, one side of the top section 602 may attach to the right pivot 608 and one side of the top section 602 may attach to the left pivot 606. The right and left pivots 608, 606 may also be motorized to move the robotic arm. The motor controlling the left and right pivots 608, 606 may be controlled by the robotic arm controller and may be the same motor that controls the rotation of the base platform 512. The motor controlling the left and right pivots 608, 606 may also be a separate motor. In embodiments, having two separate motors, the motor for the left and right pivots 608, 606 may be disposed inside the right and/or left pivots 608, 606 or inside the bottom section 604 of the base platform 512.

FIGS. 7A-7C illustrate a telescoping robotic arm embodiment according to the present disclosure. In various embodiments, the telescoping arm may collapse to reduce the length of the arm. To collapse the arm, each section of the telescoping arm may contract inside the section immediately below the contracted section until each section of the telescoping arm is disposed inside the base section at the bottom end of the robotic arm opposite the camera attachment platform. FIG. 7A illustrates a shortened position with most of the sections of the telescoping arm contracted. To increase the length of the robotic arm, the sections included in the telescoping arm may extend out from the base section. FIG. 7B shows a first extended position with some of the sections extended and FIG. 7C shows a second extended positon with some additional sections extended. In various embodiments, when all of the sections are extended from the base section, the robotic arm is at its maximum length.

The sections may be contracted and/or extended using a known mechanical and/or motorized movement mechanism. Motorized movement mechanism may be controlled by the robotic arm controller. In various embodiments, a motor for controlling the movement of the sections may be independent from the motor controlling the rotating platform and/or right and left pivots. The telescoping arm motor may be disposed in the base section of the telescoping arm and/or the top and/or bottom section of the base platform. In various embodiments, the motor that controls the base platform and/or the right and left pivots may also extend and/or contract sections of the telescoping arm.

FIGS. 7D-7E illustrate the upper joint 504 in more detail. FIG. 7D shows an extended configuration of the upper joint 504 with the camera attachment platform 502 extended out from the robotic arm. FIG. 7E illustrates an angled configuration of the upper joint 504 with the camera attachment platform 502 bent 90° relative to its position in the extended configuration. The left pivot of the robotic arm shown in 7E is also fully activated to position the robotic arm in an extreme left position with the arm portion fully horizontal and extended to the left from center. As described above, the gimbal 506 may stabilize the camera during movement of the camera attachment platform 502, rotating platform, arm portion, right pivot, left pivot, and/or any other portion of the robotic arm by isolating the camera from vibrations and movements of the robotic camera arm.

FIG. 7F illustrates exemplary axes of rotation provided by the components of the robotic arm. In various embodiments, the base platform 512 may rotate the robotic arm up to 360° along a y axis that extends vertically up from the base platform 512 and is perpendicular to the ground. As shown in FIG. 7F, the y axis of rotation may be a vertical axis of rotation that extends longitudinally up from the base platform. When the arm portion 508 is in a center position, the vertical axis of rotation (i.e., the y axis) may extend vertically up from the base platform 512 to the camera attachment platform 502 along the arm portion 508. The y axis may be a vertical axis and the angle of rotation provided by the rotation of the base platform 512 may be a yaw angle of rotation. In various embodiments, the lower joint 514 may rotate the arm portion 508 up to 180° along an x axis. The x axis may be a horizontal axis of rotation that may be perpendicular to the y axis of rotation provided by the base platform 512. The horizontal axis of rotation may extend horizontally out from the base platform 512. The x axis may be a longitudinal axis and the angle of rotation provided by the rotation of the lower joint 514 may be a roll angle of rotation. In various embodiments, the upper joint 504 may rotate the camera attachment platform 502 up to 180° along a z axis that may be perpendicular to the y axis of rotation provided by the base platform 512 and/or the x axis of rotation provided by the lower joint 514. The z axis may be lateral axis and the angle of rotation provided by the rotation of the upper joint 504 may be a pitch angle of rotation. The z axis may also be a vertical axis of rotation that extends longitudinally up from the base platform 512.

FIGS. 8A-C illustrate exemplary mechanical mounting systems that may be used to fix the camera 102 to the camera attachment platform 502. Mounting systems may be removably attached and/or built into the back of the camera 102 to enable quick and secure attachment to the camera attachment platform 502. Once secured to the camera attachment platform 502 the position of the camera 102 may be changed using the robotic arm. Mechanical mounting systems that may secure the camera 102 to the camera attachment platform 502 may include hooks, clips, suction cups, mini suction cups, disposable sticky pads, magnets, and the like. Mechanical and/or electroadhesion mounting systems may be removably attached and/or permanently fixed to the camera 102 using one or more receiving wells 818 included in a rear surface of the camera 102.

FIGS. 8A-B illustrate an exemplary mechanical hook mounting system including two or more hooks 808 extending from an exterior surface 806 of the camera attachment platform 502 and two or more receiving wells 818 formed in a back surface 816 of the camera 102. To attach the camera 102 to the camera attachment platform 502, the two or more hooks 808 are inserted into the two or more receiving wells 818, Once inside the receiving wells 818, the hooks 808 may lock into place to secure the camera 102 to the camera attachment platform 502. To detach the camera 102 form the camera attachment platform 502, the hooks are unlocked at removed from the receiving wells. FIG. SC illustrates the camera 102 after it has been attached to the robotic arm via the camera attachment platform 502.

As shown in FIG. 8B, the back surface 816 of the camera 102 may include four receiving wells 818 arranged in two pairs of two. The hooks on the camera attachment platform 502 may be inserted into either pair of receiving wells 818. The position of the camera on the camera attachment platform 502. may be changed by changing the pair of receiving wells 818 the hooks lock into. In various embodiments, mechanical hook mounting systems may include more or fewer than two hooks 808 and/or four receiving wells 818. The hooks 808 and/or receiving wells 818 may be positioned on the exterior surface 806 of the camera attachment platform and/or the back surface of the camera 102.

FIGS. 9-10C pertain to electroadhesion mounting systems for securing the camera 102 to the camera attachment platform of a robotic arm.

FIG. 9 illustrates and electroadhesion device 900 that may be included in the camera and/or the robotic arm. In various embodiments, the electroadhesion device 900 can be implemented a compliant film comprising one or more electrodes 904 and an insulating material 902 between the electrodes 904 and the camera or robotic arm. The electroadhesive film may include a chemical adhesive applied to the insulating material 902 and/or electrodes 904 to allow the electroadhesion device 900 to be attached to the back of the camera 102 and/or surface of the robotic arm 118. Additional attachment mechanisms used to secure the electroadhesion device 900 to the camera 102 and/or robotic arm 118 may include a mechanical fastener, a heat fastener (e.g., welded, spot welded, or spot-melted location), dry adhesion, Velcro, suction/vacuum adhesion, magnetic or electromagnetic attachment, tape (e.g.: single- or double-sided), and the like. Depending on the degree of device portability desired or needed for a given situation and the size of the electroadhesion device 900, the attachment mechanism may create a permanent, temporary, or removable form of attachment.

The insulating material 902 may be comprised of several different layers of insulators. For purposes of illustration, the electroadhesion device 900 is shown as having four electrodes in two pairs, although it will be readily appreciated that more or fewer electrodes can be used in a given electroadhesion device 900. Where only a single electrode is used in a given electroadhesion device 900, a complimentary electroadhesion device having at least one electrode of the opposite polarity is preferably used therewith. With respect to size, electroadhesion device 900 is substantially scale invariant. That is, electroadhesion device 900 sizes may range from less than 1 square centimeter to greater than several meters in surface area. Even larger and smaller surface areas are also possible and may be sized to the needs of a given camera system, camera, and/or robotic arm.

In various embodiments, the electroadhesion device 900 may cover the entire rear surface of the camera, the entire front surface of the camera attachment platform, and or the entire bottom surface of a robotic arm base platform. One or more electrodes 904 may be connected to a power supply 912 (e.g., battery, AC power supply, DC, power supply and the like) using one or more known electrical connections 906. A power management integrated circuit 910 may manage power supply 912 output, regulate voltage, and control power supply 912 changing functions. To create an electroadhesive force to support a camera and/or robotic arm, low voltage power from a power supply must be converted into high voltage charges at the one or more electrodes 904 using a voltage converter 908. The high voltage charges on the one or more electrodes 904 forms an electric field that interacts with a target surface in contact with— and/or proximate to—the electroadhesion device 900. The electric field may locally polarize the target surface and/or induce direct charges on the target surface that are opposite to the charge on the one or more electrodes 904. The opposite charges on the one or more electrodes and the target surface attract causing electrostatic adhesion between the electrodes and the target surface. The induced charges may be the result of a dielectric polarization or from weakly conductive materials and electrostatic induction of charge. In the event that the target surface is a strong conductor, such as copper for example, the induced charges may completely cancel the electric field. In this case, the internal electric field is zero, but the induced charges nonetheless still form and provide electroadhesive force (i.e., Lorentz forces) to the electroadhesion device 900.

Thus, the voltage applied to the one or more electrodes 904 provides an overall electroadhesive force, between the electroadhesion device 900 and the material of the target surface. The electroadhesive force holds the electroadhesion device 900 on the target surface to hold the camera and/or robotic arm in place. The overall electroadhesive force may be sufficient to overcome the gravitational pull on the camera or robotic arm such that the electroadhesion device 900 may be used to hold the camera and/or robotic arm aloft on the target surface. In various embodiments, a plurality of electroadhesion devices may be placed against a target surface, such that additional electroadhesive forces against the surface can be provided. The combination of electroadhesive forces may be sufficient to lift, move, pick and place, or otherwise handle the target surface. Electroadhesion device 900 may also be attached to other structures and/or objects and hold these additional structures aloft, or it may be used on sloped or slippery surfaces to increase normal or lateral friction forces.

Removal of the voltages from the one or more electrodes 904 ceases the electroadhesive force between electroadhesion device 900 and the target surface. Thus, when there is no voltage between the one or more electrodes 904, electroadhesion device 900 can move more readily relative to the target surface. This condition allows the electroadhesion device 900 to move before and after the voltage is applied. Well controlled electrical activation and deactivation enables fast adhesion and detachment, such as response times less than about 50 milliseconds, for example, while consuming relatively small amounts of power.

Applying too much voltage to certain materials (e.g., metals and other conductors) can cause sparks, fires, electric shocks, and other hazards. Applying too little voltage generates a weak electroadhesion force that is not strong enough to securely attach the electroadhesion device 900 to the target surface. To ensure the proper adjustable voltage is generated and applied to the electrodes 904, a digital switch 916 may autonomously control the voltage converter 908. The digital switch 916 may control the voltage output of the voltage converter 908 based on sensor data collected by one or more sensors 914 included in the electroadhesion device 900. The digital switch 916 may be a microcontroller or other integrated circuit including programmable logic for receiving sensor data, determining one or more characteristics based on the sensor data, and controlling the voltage converter based on the one or more characteristics. The digital switch 916 may operate the voltage converter to generate, modify, set, and/or maintain an adjustable output voltage used to attach the electroadhesion device 900 to a target surface.

For example, in response to detecting a conductive target surface (e.g., metal) by the sensor 914, the digital switch 916 may cause the voltage converter 908 to generate an adjustable voltage sufficient to attach and secure the electroadhesion device 900 to the conductive target surface. The adjustable voltage output may also be sate to apply to conductive surfaces and may eliminate sparks, fires, or other hazards that are created when an electroadhesion device 900 that is generating a high voltage contacts and/or is placed close to a conductive target surface. Similarly, when the sensor 914 detects a different surface with different characteristics, the digital switch 916 controls the voltage converter 908 to generate a different adjustable voltage that is sufficient to attach and secure the electroadhesion device 900 to that different surface. For example, in response to detecting an organic target surface (e.g., wood, drywall, fabric, and the like) by the sensor 914, the digital switch 916 may cause the voltage converter 908 to generate an adjustable voltage that may be sufficient to attach and secure the electroadhesion device 900 to the organic target surface without creating hazards. The adjustable voltage may also minimize the voltage output to avoid hazards that may be created when the electroadhesion device 900 is accidently moved. In response to detecting a smooth target surface (e.g., glass) or an insulating target surface (e.g., plastic, stone, sheetrock, ceramics, and the like) by the sensor 914, the digital switch 916 may cause the voltage converter 908 to generate an adjustable voltage sufficient to attach and secure the electroadhesion device 900 to the smooth and/or insulating target surface without creating hazards. Thus, the electroadhesion device 900 has an adjustable voltage level that is adjusted based on a characteristic of the surface determined by the sensor 914 resulting in an electroadhesion device 900 that can be safely used to attach to various target surfaces without safety hazards.

The strength (i.e. amount of voltage) of the adjustable voltage may vary depending on the material of the target surface. For example, the strength of the adjustable voltage required to attach the electroadhesion device 900 to a conductive target surface (e.g., metal) may be higher than the adjustable voltage required to attach the electroadhesion device 900 to an insulating target surface, a smooth target surface, and/or an organic target surface. The strength of the adjustable voltage required to attach the electroadhesion device 900 to an organic target surface may be greater than the adjustable voltage required to attach the electroadhesion device 900 to a conductive target surface and less than the adjustable voltage require to attach the electroadhesion device 900 to an insulating target surface. The strength of the adjustable voltage required to attach the electroadhesion device 900 to an insulating target surface may be higher than the adjustable voltage required to attach the electroadhesion device 900 to an organic target surface or a conductive target surface. The electroadhesion device 900 may be configured to attach to any type of surface (e.g., metallic, organic, rough, smooth, undulating, insulating. conductive, and like). In some embodiments, it may be preferable to attach the electroadhesion device 900 to a smooth, flat surface.

Attaching the electroadhesion device 900 to some target surfaces requires a very high voltage. For example, a very high voltage output may be required to attach the electroadhesion device 900 to a rough target surface, a very smooth target surface (e.g., glass), and/or an insulating target surface. An electroadhesion device 900 generating a high voltage output may generate sparks, fires, electric shock, and other safety hazards when placed into contract with— and/or in dose proximity to—conductive surfaces. To avoid safety hazards, some embodiments of the electroadhesion device 900 may not generate a high voltage and may only generate an output voltage sufficient to attach the electroadhesion device 900 to conductive target surfaces, organic target surfaces, and the like.

When the electroadhesion device 900 is moved to a new target surface, the sensor 914 may automatically detect one or more characteristics of the new target surface and/or determine the material type for the new target surface. The digital switch 916 may then modify and/or maintain the voltage output generated by the voltage converter 908 based on the material type and/or characteristics for the new target surface. To determine the adjustable voltage to generate using the voltage converter 908, the digital switch 916 may include logic for determining the voltage based on sensor data received from the sensor 914. For example, the digital switch 916 may include logic for using a look up table to determine the proper adjustable voltage based on the sensor data. The logic incorporated into the digital switch 916 may also include one or more algorithms for calculating the proper adjustable voltage based on the sensor data. Additionally, if the sensor 914 detects the electroadhesion device 900 is moved away from a target surface, the digital switch 916 may power down the voltage converter 908 and/or otherwise terminate voltage output from the voltage converter 908 until a new target surface is detected by the sensor 914.

The one or more sensors 914 can include a wide variety of sensors 914 for measuring characteristics of the target surface. Each sensor 914 may be operated by a sensor control circuit 918. The sensor control circuit 918 may be included in the sensor 914 or may be a distinct component. The sensor control circuit 918 can be a microcontroller or other integrated circuit having programmable logic for controlling the sensor 914. For example, the sensor control circuit may initiate capture of sensor data, cease capture of sensor data, set the sample rate for the sensor, control transmission of sensor data measured by the sensor 914, and the like. Sensors 914 can include conductivity sensors (e.g., electrode conductivity sensors, induction conductivity sensors, and the like); Hall effect sensors and other magnetic field sensors; porosity sensors (e.g., time domain reflectometry (TDR) porosity sensors); wave form sensors (e.g., ultrasound sensors, radar sensors, infrared sensors, dot field projection depth sensors, time of flight depth sensors); motion sensors; and the like. Sensor data measured by the one or more sensors 914 may be used to determine one or more characteristics of the target surface. For example, sensor data may be used to determine the target surface's conductivity and other electrical or magnetic characteristics; the material's porosity, permeability, and surface morphology; the materials hardness, smoothness, and other surface characteristics; the distance the target surface is from the sensor; and the like. One or more characteristics determined from sensor data may be used to control the digital switch 916 directly. Sensor data may be analyzed by one or more applications of other pieces of software (e.g., a data analysis module) included in the camera, robotic arm, or in a remote computer device (e.g., a server). In particular, sensor data collected by the one or more sensors 914 may be refined and used to determine a characteristic and/or material type (e.g., metal, wood, plastic, ceramic, concreate, drywall, glass, stone and the like) for the target surface. The digital switch 916 may then control the voltage output from the voltage converter 908 based on the characteristic and/or material type for the target surface determined by the data analysis module.

The digital switch 916 may function as an essential safety feature of the electroadhesion device 900. The digital switch 916 may reduce the risk of sparks, fires, electric shock, and other safety hazards that may result from applying a high voltage to a conductive target surface. By autonomously controlling the voltage generated by the electroadhesion device 900, the digital switch 916 may also minimize human error that may result when a user manually sets the voltage output of the electroadhesion device 900. For example, human errors may include a user forgetting to change the voltage setting, a child playing with the electroadhesion device and not paying attention to the voltage setting, a user mistaking a conductive surface for an insulating surface, and the like. These errors may be eliminated by using digital switch 916 to automatically adjust the voltage generated by the voltage converter 908 based on sensor data received from the one or more sensors 914 and/or material classifications made by the data analysis module.

To promote safely and improve user experience, the electroadhesion device 900 and/or the camera 102 or robotic arm 118 integrated with the electroadhesion device 900 may include a mechanism (e.g., button, mechanical switch, UT element, and the like) for actuating the sensor 914 and/or digital switch 916. The sensor 914 and digital switch 916 may also be automatically turned on when the electroadhesion device 900, the camera 102, and/or robotic arm 118 is powered on. The electroadhesion device 900, the camera 102, and/or robotic arm 118 may also include a signaling mechanism (e.g., status light, UI element, mechanical switch, and the like) for communicating the status of the sensor 914 and/or digital switch 916 to a user of the electroadhesion device 900. The signaling mechanism may be used to communicate that the proper adjustable voltage for a particular target surface has been determined.

In various embodiments, the signaling mechanism may be a status light that is red when the sensor 914 and/or digital switch 916 is powered on and sensing the target surface material but has not determined the proper adjustable voltage for the target surface. The status light may turn green when the digital switch 916 has received the sensor data, determined the appropriate voltage for the particular target surface, and generated the proper adjustable voltage output and the electroadhesion device 900 is ready to attach to the target surface. The status light may also turn blinking red and/or yellow if there is some problem with determining the voltage for the particular target surface and/or generating the adjustable voltage output for the particular target surface. For example, the status light may blink red and/or turn yellow when the sensor 914 is unable to collect sensor data, the data analysis module is unable to determine a material type for the target surface material, the digital switch 916 is unable to operate the voltage converter 908, the voltage converter 908 is unable to generate the correct voltage, and the like.

As described herein, voltage generated by the voltage converter 908 is defined as a range of DC voltage of any one or more of the following from 250 V to 10,000 V; from 500 V to 10,000 V; from 1,000 V to 10,000 V; from 1,500 V to 10,000 V; from 2,000 V to 10,000 V; from 3,000 V to 10,000 V; from 4,000 V to 10,000 V; from 5,000 V to 10,000 V; from 6,000 V to 10,000 V; from 7,000 V to 10,000 V; from 250 V to 1,000 V; from 250 V to 2,000 V; from 250 V to 4,000 V; from 500 V to 1,000 V; from 500 V to 2,000 V; from 500 V to 4,000 V; from 1,000 V to 2,000 V; from 1,000 V to 4,000 V; from 1,000 V to 6,000 V; from 2,000 V to 4,000 V; from 2,000 V to 6,000 V; from 4,000 V to 6,000 V; from 4,000 V to 10,000 V; from 6,000 V to 8,000 V; and from 8,000 V to 10,000 V.

As described herein, voltage generated by the voltage converter 908 is defined as a range of AC voltage of any one or more of the following from 250 Vᵣₘₛ to 10,000 Vᵣₘₛ; from 500 Vᵣₘₛ to 10,000 Vᵣₘₛ; from 1,000 Vᵣₘₛ to 10,000 Vᵣₘₛ; from 1,500 Vᵣₘₛ to 10,000 Vᵣₘₛ; from 2,000 Vᵣₘₛ to 10,000 Vᵣₘₛ; from 3,000 Vᵣₘₛ to 10,000 Vᵣₘₛ; from 4,000 Vᵣₘₛ to 10,000 Vᵣₘₛ; from 5,000 Vᵣₘₛ to 10,000 Vᵣₘₛ; from 6,000 Vᵣₘₛ to 8,000 Vᵣₘₛ; from 7,000 Vᵣₘₛ to 8,000 Vᵣₘₛ; from 8,000 Vᵣₘₛ to 10,000 Vᵣₘₛ; from 9,000 Vᵣₘₛ to 10,000 Vᵣₘₛ; from 250 Vᵣₘₛ to 1,000 Vᵣₘₛ; from 250 Vᵣₘₛ to 2,000 Vᵣₘₛ; from 250 Vₘ to 4,000 Vᵣₘₛ; from 500 Vᵣₘₛ to 1,000 Vᵣₘₛ; from 500 Vᵣₘₛ to 2,000 Vᵣₘₛ; from 500 Vᵣₘₛ to 4,000 Vᵣₘₛ; from 1,000 V to 2,000 Vᵣₘₛ; from 1,000 Vᵣₘₛ to 4,000 Vᵣₘₛ; from 1,000 V to 6,000 Vᵣₘₛ; from 2,000 Vᵣₘₛto 4,000 Vᵣₘₛ; from 2,000 Vᵣₘₛto 6,000 Vᵣₘₛ; from 4,000 Vᵣₘₛ to 6,000 Vᵣₘₛ; from 4,000 Vᵣₘₛto 8,000 Vᵣₘₛ; and from 6,000 Vᵣₘₛto 8,000 Vᵣₘₛ.

As described herein, voltage generated by the voltage converter 908 is defined as a range of DC voltage of any one or more of the following from about 250 V to about 10,000 V; from about 500 V to about 10,000 V; from about 1,000 V to about 10,000 V; from about 1,500 V to about 10,000 V; from about 2,000 V to about 10,000 V; from about 3,000 V to about 10,000 V; from about 4,000 V to about 10,000 V; from about 5,000 V to about 10,000 V; from about 6,000 V to about 8,000 V; from about 7,000 V to about 8,000 V; from about 250 V to about 1,000 V; from about 250 V to about 2,000 V; from about 250 V to about 4,000 V; from about 500 V to about 1,000 V; from about 500 V to about 2,000 V; from about 500 V to about 4,000 V; from about 1,000 V to about 2,000 V; from about 1,000 V to about 4,000 V; from about 1,000 V to about 6,000 V; from about 2,000 V to about 4,000 V; from about 2,000 V to about 6,000 V; from about 4,000 V to about 6,000 V; from about 4,000 V to about 8,000 V; from about 6,000 V to about 8,000 V; from about 8,000 V to about 10,000 V; and from about 9,000 V to about 10,000 V.

As described herein, voltage generated by the voltage converter 908 is defined as a range of AC voltage of any one or more of the following from about 250 Vᵣₘₛ to about 10,000 Vᵣₘₛ; from about 500 Vᵣₘₛto about 10,000 Vᵣₘₛ; from about 1,000 Vᵣₘₛ to about 10,000 Vᵣₘₛ; from about 1,500 Vᵣₘₛ to about 10,000 Vᵣₘₛ; from about 2,000 Vᵣₘₛ to about 10,000 Vᵣₘₛ; from about 3,000 Vᵣₘₛ to about 10,000 Vᵣₘₛ; from about 4,000 Vᵣₘₛ to about 10,000 Vᵣₘₛ; from about 5,000 Vᵣₘₛ to about 10,000 Vᵣₘₛ; from about 6,000 Vᵣₘₛ to about 8,000 Vᵣₘₛ; from about 7,000 Vᵣₘₛ to about 8,000 Vᵣₘₛ; from about 250 Vᵣₘₛ to about 1,000 Vᵣₘₛ; from about 250 Vᵣₘₛ to about 2,000 Vᵣₘₛ; from about 250 Vᵣₘₛ to about 4,000 Vᵣₘₛ; from about 500 Vᵣₘₛ to about 1,000 Vᵣₘₛ; from about 500 Vᵣₘₛ to about 2,000 Vᵣₘₛ; from about 500 Vᵣₘₛ to about 4,000 Vᵣₘₛ; from about 1,000 Vᵣₘₛ to about 2,000 Vᵣₘₛ; from about 1,000 Vᵣₘₛ to about 4,000 Vᵣₘₛ; from about 1,000 Vᵣₘₛ to about 6,000 Vᵣₘₛ; from about 2,000 Vᵣₘₛ to about 4,000 Vᵣₘₛ; from about 2,000 Vᵣₘₛ to about 6,000 Vᵣₘₛ; from about 4,000 Vᵣₘₛ to about 6,000 Vᵣₘₛ; from about 4,000 Vᵣₘₛ to about 8,000 Vᵣₘₛ; from about 6,000 Vᵣₘₛ to about 8,000 Vᵣₘₛ; from about 8,000 Vᵣₘₛ to about 10,000 Vᵣₘₛ; and from about 9,000 Vᵣₘₛ to about 10,000 Vᵣₘₛ.

As described herein, voltage output from the power supply 912 is defined as a range of DC voltage of any one or more of the following from 2.0 V to 249.99 V; from 2.0 V to 150.0 V; from 2.0 V to 100.0 V; from 2.0 V to 50.0 V; from 5.0 V to 249.99 V; from 5.0 V to 150.0 V; from 5.0 V to 100.0 V; from 5.0 V to 50.0 V; from 50.0 V to 150.0 V; from 100.0 V to 249.99 V; from 100.0 V to 130.0 V; and from 10.0 V and 30.0 V.

As described herein, voltage output from the power supply 912 is defined as a range of AC voltage of any one or more of the following from 2.0 Vᵣₘₛ to 249.99 Vᵣₘₛ; from 2.0 Vᵣₘₛ to 150.0 Vᵣₘₛ; from 2.0 Vᵣₘₛ to 100.0 Vᵣₘₛ; from 2.0 Vᵣₘₛ to 50.0 Vᵣₘₛ; from 5.0 Vᵣₘₛ to 249.99 Vᵣₘₛ; from 5.0 Vᵣₘₛ to 150.0 Vᵣₘₛ; from 5.0 Vᵣₘₛ to 100.0 Vᵣₘₛ; from 5.0 Vᵣₘₛ to 50.0 Vᵣₘₛ; from 50.0 Vᵣₘₛ to 150.0 Vᵣₘₛ; from 100.0 Vᵣₘₛ to 249.99 Vᵣₘₛ; from 100.0 Vᵣₘₛ to 130.0 Vᵣₘₛ; and from 10.0 Vᵣₘₛ and 30.0 Vᵣₘₛ.

As described herein, voltage output from the power supply 912 is defined as a range of DC voltage of any one or more of the following from about 2.0 V to about 249.99 V; from about 2.0 V to about 150.0 V; from about 2.0 V to about 100.0 V; from about 2.0 V to about 50.0 V; from about 5.0 V to about 249.99 V; from about 5.0 V to about 150.0 V; from about 5.0 V to about 100.0 V; from about 5.0 V to about 50.0 V; from about 50.0 V to about 150.0 V; from about 100.0 V to about 249.99 V; from about 100.0 V to about 130.0 V; and from about 10.0 V and 30.0 V.

As described herein, voltage output from the power supply 912 is defined as a range of AC voltage of any one or more of the following from about 2.0 Vᵣₘₛ to about 249.99 Vᵣₘₛ; from about 2.0 Vᵣₘₛ to about 150.0 Vᵣₘₛ; from about 2.0 Vᵣₘₛ to about 100.0 Vᵣₘₛ; from about 2.0 V to about 50.0 Vᵣₘₛ; from about 5.0 Vᵣₘₛ to about 249.99 Vᵣₘₛ; from about 5.0 Vᵣₘₛ to about 150.0 Vᵣₘₛ; from about 5.0 Vᵣₘₛ to about 100.0 Vᵣₘₛ; from about 5.0 Vᵣₘₛ to about 50.0 Vᵣₘₛ; from about 50.0 Vᵣₘₛ to about 150.0 Vᵣₘₛ; from about 100.0 Vᵣₘₛ to about 249.99 Vᵣₘₛ; from about 100.0 Vᵣₘₛ to about 130.0 Vᵣₘₛ; and from about 10.0 Vᵣₘₛ and 30.0 Vᵣₘₛ.

FIGS. 10A-C illustrate a camera 102 and a robotic arm having an electroadhesion device 900 mounting system. In various embodiments, the electroadhesion device 900 may be used to mount the camera 102 to the camera attachment platform 502 of the robotic arm 118 and/or the surface of any target surface or object including walls, mirrors, trees, furniture, and the like. FIG. 10A illustrates a back surface 816 of the camera 102 having an electroadhesion device 900, for example, a compliant electroadhesive film fixed to the back surface 816. The sensor 914 for determining the target surface material shown on the camera 102 may be separate from and/or integrated into the electroadhesive film. FIG. 10B illustrates a surface of the camera attachment platform 502 having an electroadhesion device 900, for example, a compliant electroadhesive film fixed to the camera attachment platform 502 of the robotic arm. The sensor 914 shown on the camera attachment platform 502 may be separate from and/or integrated into the electroadhesive film.

FIG. 10C illustrates a side view of the camera 102 mounted to a robotic arm 118 using the electroadhesion device 900. In this example, the electroadhesion device 900 is mounted to the camera 102. To attach the camera 102 to the camera attachment platform 502, the sensor 914 determines the material of the target surface of camera attachment platform 502. In various embodiments, the sensor 914 may emit a signal, pulse, or other waveform transmission towards the target surface. The sensor 914 may then detect a signal reflected back off of the target surface as sensor data. Sensor data is then used to determine one or more characteristics and/or material types for a target surface. Based on the characteristics and/or material types identified using sensor data, the voltage generated and applied to each of the electrodes 904 is adjustably controlled using the digital switch 916. Adjusting the voltage output of the electrodes 904 according to the target material, eliminates sparks, fires, electric shock, and other safety hazards that may result when too much voltage is applied to conductive target surfaces. The sensors 914 may also be used to detect an authorized user of the electroadhesion device 900 to minimize human error, accidental voltage generation, and unintended operation of the electroadhesion device 900.

To attach the camera to the target surface on the camera attachment platform 502, an electroadhesive force is generated by the one or more electrodes 904 in response to the adjustable voltage. The electroadhesive force may be generated using alternating positive and negative charges on adjacent electrodes 904. The voltage difference between the electrodes 904 induces a local electric field 1020 in the camera attachment platform 502 around the one or more electrodes 904. The electric filed 1020 in the camera attachment platform locally polarizes the surface of the camera attachment platform 502 and causes an electrostatic adhesion between the electrodes 904 of the electroadhesion device 900 and the induced charges on the surface of the camera attachment platform 502. For example, the electric field 1020 may locally polarize the source of the camera attachment platform 502 to cause electric charges (e.g., electric charges having opposite polarity to the charge on the electrodes 904) from the inner portion of the camera attachment platform 502 to build up on an exterior surface of the camera attachment platform around the surface of the electrodes 904. The build-up of opposing charges creates an electroadhesive force between the electroadhesion device 900 attached to the camera 102 and the camera attachment platform 502.

The electroadhesive force is sufficient to fix the camera 102 to the camera attachment platform 502 while the voltage is applied. It should be understood that the electroadhesion device 900 does not have to be in direct content with the surface of the camera attachment platform 502 to produce the electroadhesive force. Instead, the surface of the camera attachment platform 502 must be proximate to the electroadhesion device 900 to interact with the voltage on the one or more electrodes 904 that provides the electroadhesive force. The electroadhesion device 900 may, therefore, secure the camera 102 to smooth, even surfaces as well as rough, uneven surfaces.

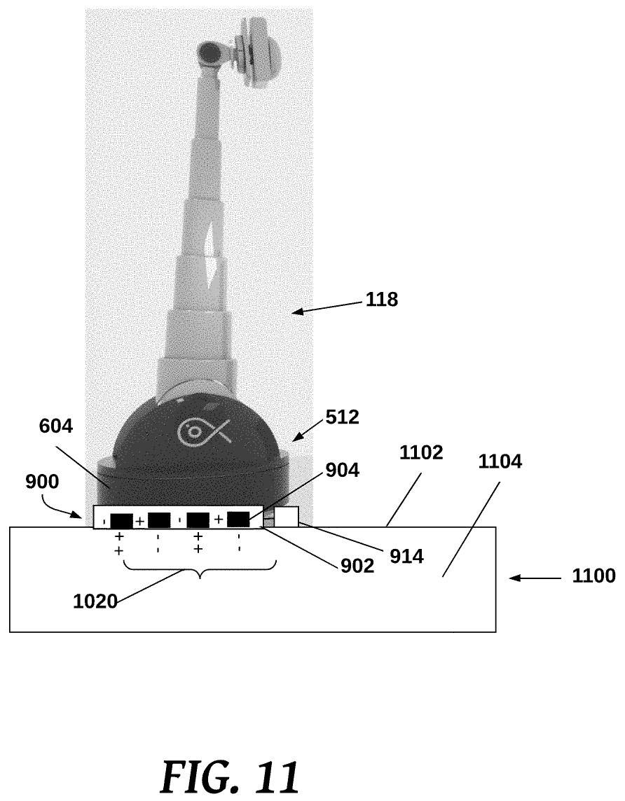

FIG. 11 illustrates a robotic arm 118 having an electroadhesion device 900 formed on the bottom section 604 of the base platform 512. In various embodiments, the electroadhesion device 900 may be used to mount the robotic arm 118 to a target surface 1100, for example, walls, mirrors, trees, furniture, and the like. Using the electroadhesion device 900 to attach the robotic arm 118 to the target surface 1100 provides a stabilizing force that steadies the robotic arm 118 to prevent vibration and other unwanted motion from affecting the performance of the camera 102. Securing the robotic arm 118 to the target surface with the electroadhesion device 900 also prevents the robotic arm 118 from tipping over when the robotic arm 118 is extended. Using the electroadhesion force provided by the electroadhesion device 900 to hold the robotic arm 118 in place and prevent it from tipping over reduces the weight of the robotic arm 118 by substituting a heavy weighted base used to hold the robotic arm 118 in place with the electroadhesion force provided by the electroadhesion device 900. The electroadhesion device 900 may be in the form of a compliant film comprising one or more electrodes 904 and an insulating material 902 between the electrodes 904 and the robotic arm. The electroadhesion film may include a chemical adhesive applied to the insulating material 902 and/or electrodes 904 to allow the electroadhesion device to be attached to a surface of the robotic arm (e.g., the bottom of the base platform 512). FIG. 11 shows a side view of the robotic arm 118 mounted to a target surface 1100 using the electroadhesion device 900.

To attach the robotic arm 118 to the target surface 1100, based on the characteristics and/or material types identified using sensor data, the voltage generated and applied to each of the electrodes 904 is adjustably controlled using the digital switch 916. Adjusting the voltage output of the electrodes 904 according to the material of the target surface 1100, eliminates sparks, fires, electric shock, and other safety hazards that may result when too much voltage is applied to conductive target surfaces. An electroadhesive force is be generated by the one or more electrodes 904 in response to the adjustable voltage. The electroadhesive force may be generated using alternating positive and negative charges on adjacent electrodes 904. The voltage difference between the electrodes 904 induces a local electric field 1020 in the target surface 1100 around the one or more electrodes 904. The electric filed 1020 locally polarizes the target surface 1100 and causes the electroadhesive force between the electrodes 904 of the electroadhesion device 900 and the induced charges on the target surface 1100. For example, the electric field 1020 may locally polarize the target surface 1100 to cause electric charges (e.g., electric charges having opposite polarity to the charge on the electrodes 904) from the inner portion 1104 of the target surface 1100 to build up on an exterior surface 1102 of the target surface 1100 around the surface of the electrodes 904. The build-up of opposing charges creates an electroadhesive force between the electroadhesion device 900 attached to the robotic arm 118 and the target surface 1100.

The electroadhesive force is sufficient to fix the robotic arm 118 to the target surface 1100 The electroadhesive force is sufficient to fix the robotic arm 118 to the exterior surface 1102 of the target surface 1100 while the voltage is applied. It should be understood that the electroadhesion device 900 does not have to be in direct content with the exterior surface 1102 of the target surface 1100 to produce the electroadhesive force. Instead, the exterior surface 1102 of the target surface 1100 must be proximate to the electroadhesion device 900 to interact with the voltage on the one or more electrodes 904 that provides the electroadhesive force. The electroadhesion device 900 may, therefore, secure the robotic arm 118 to smooth, even surfaces as well as rough, uneven surfaces.

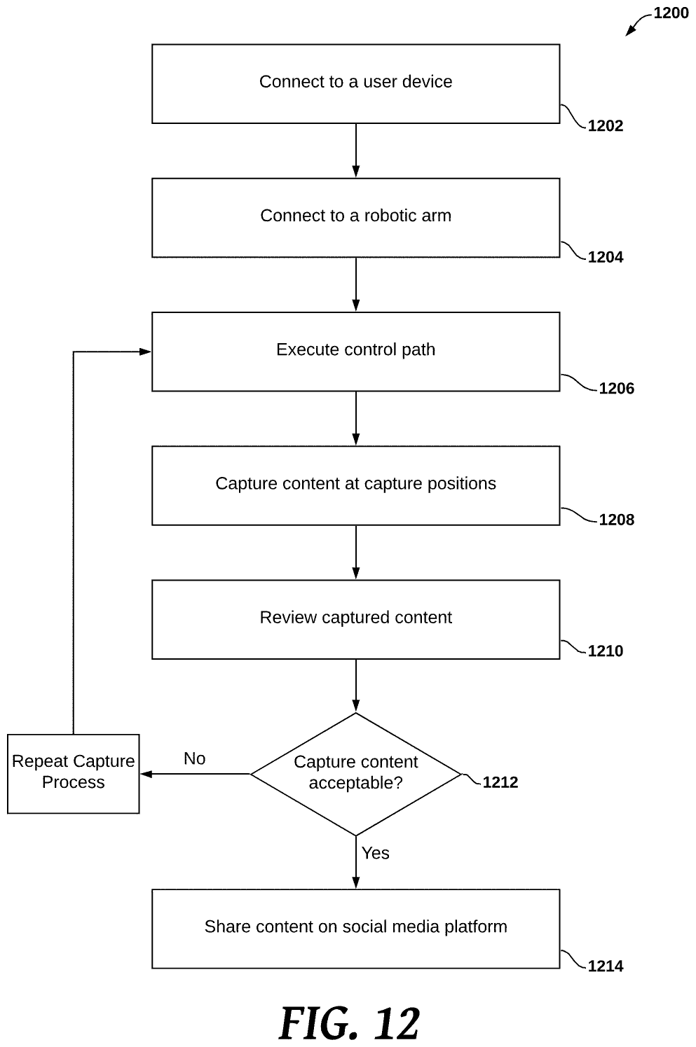

FIG. 12 illustrates an exemplary process for capturing content using the camera system shown in FIGS. 1-2. At step 1202, a camera connects to a user device and/or other remote computer to establish a communication pathway for transferring messages and data. In various embodiments a communications component of the camera may send and receive digital data from the user device and/or other remote computer to establish a connection with the user device and/or other remote computer. At step 1204, the camera, user device, and/or other remote computer may connect to a robotic arm to synchronize content capture performed by the camera with movements of the robotic arm. Once connected to the robotic arm, the robotic arm may execute a control path to move the camera, at step 1206. The control path may be selected by a user and may be executed by the robotic arm controller. The robotic arm controller may send commands to the camera to capture content when the robotic arm has positioned the camera at a capture position included in the control path. In various embodiments, a preview of the camera's field of view at each capture position may be displayed on a display of the user device and/or other remote computer once the camera reaches each capture position. One or more aspects to the image preview may be modified to simulate the appearance of content on a social media and/or video streaming platform. A user may then manually initiate the capture process of the camera based on the preview by remotely activating the camera using the user device.

In various embodiments, the camera may automatically capture one or more pieces of content at each capture position included in the control path. Once captured, pieces of content may be sent to the connected user device using the connection pathway. Captured pieces of content may then be reviewed by the user on the display of the user device at step 1210. At decision point 1212, the pieces of content are reviewed and evaluated. If the captured pieces of content shown in the preview is acceptable, the image may be saved on the user device and/or shared on a social media platform by connecting to the social media platform using the user device and transferring the image to the social media platform, at step 1214. In various embodiments, the content capture agent may automatically connect to a social media platform when a connection is established with the camera device. Once the content capture agent is connected to the social media platform, captured pieces of content may be shared on the social media platform directly from a content review GUI. If, at 1212, one or more pieces of content are not acceptable or user wants to repeat the control path to capture more content, the capture process in steps 1206-1210 may be repeated and/or the unacceptable pieces of content may be discarded. To expedite repeating the capture process, discarding one or more pieces of content may automatically restart the capture process by executing a control path to move the camera, at step 1206. Steps 1206 through 1210 may be repeated as many times as necessary to generate acceptable content.

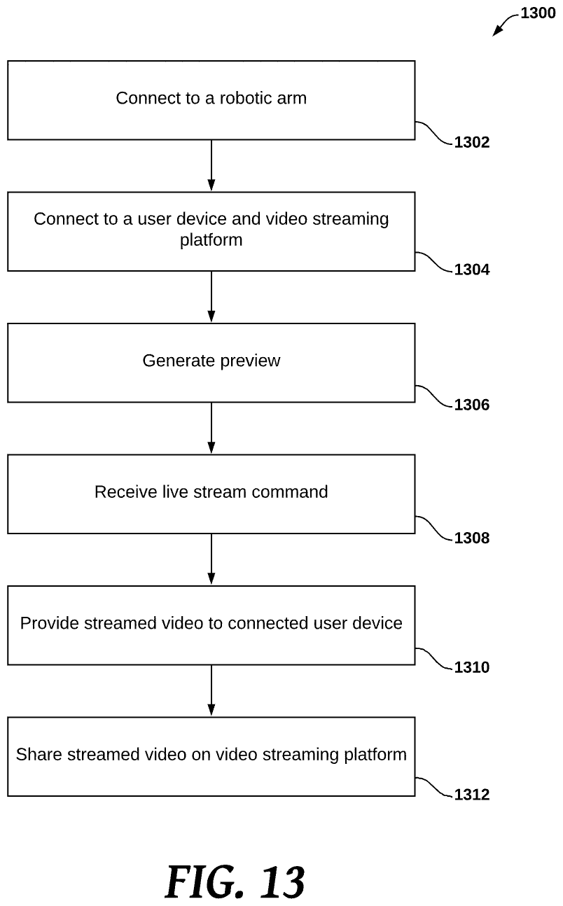

FIG. 13 illustrates an exemplary process 1300 for live streaming content captured using a camera system including a robotic arm. At step 1302, the camera is attached to the robotic arm and establishes a communicative connection with the robotic arm to synchronize the content capture performed by the camera with the movements of the robotic arm. At step 1304, the camera connects to a user device to establish a communication pathway for transferring messages and data. Once a connection is established, a streaming content (e.g., video) preview may be provided to the user device, in step 1306. The streaming content preview may be a live video stream of a scene as viewed by the camera device. One or more aspects to the preview may be modified to simulate the appearance of content displayed in the preview on a social media and/or video streaming platform. To change the appearance of the content displayed in the preview, the robotic arm may move the camera around the scene based on control commands executed by the robotic arm controller. During a live streaming session, the robotic arm may move the camera according to manual control commands provided by the user and or a control path including a series of automated movements to position the camera at one or more capture positions within the scene. At step 1308, the camera receives a live stream command from the user device and connects to a social media and/or streaming video platform. The camera may then provide streamed video content to the user device in step 1310 and simultaneously share streamed video on the video streaming platform at step 1312.

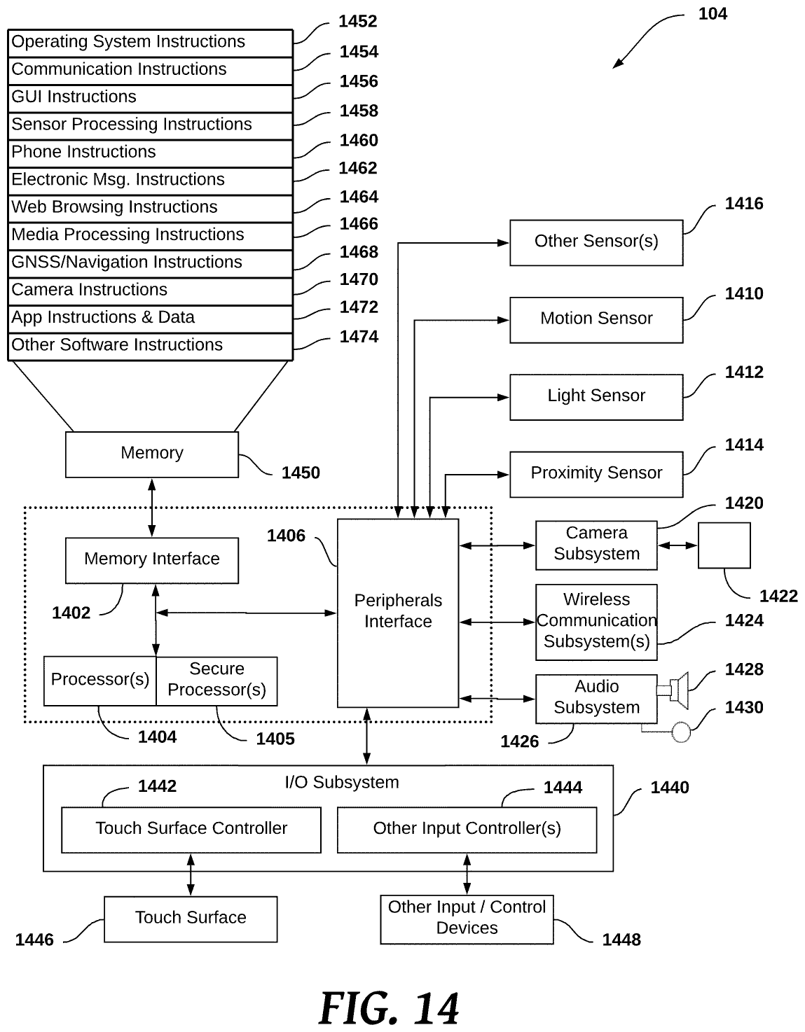

FIG. 14 shows the user device 104, according to an embodiment of the present disclosure. The illustrative user device 104 may include a memory interface 1402, one or more data processors, image processors, central processing units 1404, and/or secure processing units 1405, and a peripherals interface 1406. The memory interface 1402, the one or more processors 1404 and/or secure processors 1405, and/or the peripherals interface 1406 may be separate components or may be integrated into one or more integrated circuits. The various components in the user device 104 may be coupled by one or more communication buses or signal lines.

Sensors, devices, and subsystems may be coupled to the peripherals interface 1406 to facilitate multiple functionalities. For example, a motion sensor 1410, a light sensor 1412, and a proximity sensor 1414 may be coupled to the peripherals interface 1406 to facilitate orientation, lighting, and proximity functions. Other sensors 1416 may also be connected to the peripherals interface 1406, such as a global navigation satellite system (GNSS) (e.g., GPS receiver), a temperature sensor, a biometric sensor, depth sensor, magnetometer, or another sensing device, to facilitate related functionalities.

A camera subsystem 1420 and an optical sensor 1422, e.g., a charged coupled device (CCD) or a complementary metal-oxide semiconductor (CMOS) optical sensor, may be utilized to facilitate camera functions, such as recording photographs and video clips. The camera subsystem 1420 and the optical sensor 1422 may be used to collect images of a user to be used during authentication of a user, e.g., by performing facial recognition analysis.

Communication functions may be facilitated through one or more wired and/or wireless communication subsystems 1424, which can include radio frequency receivers and transmitters and/or optical (e.g., infrared) receivers and transmitters. For example, the Bluetooth (e.g., Bluetooth low energy (BTLE)) and/or WiFi communications described herein may be handled by wireless communication subsystems 1424. The specific design and implementation of the communication subsystems 1424 may depend on the communication network(s) over which the user device 104 is intended to operate. For example, the user device 104 may include communication subsystems 1424 designed to operate over a GSM network, a GPRS network, an EDGE network, a WiFi or WiMax network, and a Bluetooth™ network. For example, the wireless communication subsystems 1424 may include hosting protocols such that the device 104 can be configured as a base station for other wireless devices and/or to provide a WiFi service.

An audio subsystem 1426 may be coupled to a speaker 1428 and a microphone 1430 to facilitate voice-enabled functions, such as speaker recognition, voice replication, digital recording, and telephony functions. The audio subsystem 1426 may be configured to facilitate processing voice commands, voiceprinting, and voice authentication, for example.

The I/O subsystem 1440 may include a touch-surface controller 1442 and/or another input controller(s) 1444. The touch-surface controller 1442 may be coupled to a touch surface 1446. The touch surface 1446 and touch-surface controller 1442 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 1446.

The other input controller(s) 1444 may be coupled to other input/control devices 1448, such as one or more buttons, rocker switches, thumb-wheel, infrared port, USB port, and/or a pointer device such as a stylus. The one or more buttons (not shown) may include an up/down button for volume control of the speaker 1428 and/or the microphone 1430.

In some implementations, a pressing of the button for a first duration may disengage a lock of the touch surface 1446; and a pressing of the button for a second duration that is longer than the first duration may turn power to the user device 104 on or off. Pressing the button for a third duration may activate a voice control, or voice command, a module that enables the user to speak commands into the microphone 1430 to cause the device to execute the spoken command. The user may customize a functionality of one or more of the buttons. The touch surface 1446 can, for example, also be used to implement virtual or soft buttons and/or a keyboard.

In some implementations, the user device 104 may present recorded audio and/or video files, such as MP3. AAC, and MPEG files. In some implementations, the user device 104 may include the functionality of an MN player, such as an iPod™. The user device 104 may, therefore, include a 36-pin connector and/or 8-pin connector that is compatible with the iPod. Other input/output and control devices may also be used.

The memory interface 1402 may be coupled to memory 1450. The memory 1450 may include high-speed random access memory and/or non-volatile memory, such as one or more magnetic disk storage devices, one or more optical storage devices, and/or flash memory (e.g., NAND, NOR). The memory 1450 may store an operating system 1452, such as Darwin, RTIC, LINUX, UNIX, OS X, WINDOWS, or an embedded operating system such as VxWorks.

The operating system 1452 may include instructions for handling basic system services and for performing hardware dependent tasks. In some implementations, the operating system 1452 may be a kernel (e.g., UNIX kernel). In some implementations, the operating system 1452 may include instructions for performing voice authentication.

The memory 1450 may also store communication instructions 1454 to facilitate communicating with one or more additional devices, one or more computers and/or one or more servers. The memory 1450 may include graphical user interface (GUI) instructions 1456 to facilitate graphic user interface processing; sensor processing instructions 1458 to facilitate sensor-related processing and functions; phone instructions 1460 to facilitate phone-related processes and functions; electronic messaging instructions 1462 to facilitate electronic-messaging related processes and functions; web browsing instructions 1464 to facilitate web browsing-related processes and functions; media processing instructions 1466 to facilitate media processing-related processes and functions; GNSS/Navigation instructions 1468 to facilitate GNSS and navigation-related processes and instructions; and/or camera instructions 1470 to facilitate camera-related processes and functions.

The memory 1450 may store application instructions and data 1472 for recognizing GUIs displaying content on a specific social media and/or video streaming platform; capturing characteristics of content displayed in relevant GUIs; generating content previews using captured characteristics; sending content to a server device; communicating with a camera; controlling a robotic arm; synchronizing a camera with a robotic arm; and editing captured content. In various implementations, application data may include social media and/or video streaming platform content characteristics, camera control commands, robotic arm control commands, robotic arm control routes, instructions for sharing content, and other information used or generated by other applications persisted on the user device 104.

The memory 1450 may also store other software instructions 1474, such as web video instructions to facilitate web video-related processes and functions; and/or web instructions to facilitate content sharing-related processes and functions. In some implementations, the media processing instructions 1466 may be divided into audio processing instructions and video processing instructions to facilitate audio processing-related processes and functions and video processing-related processes and functions, respectively.

Each of the above-identified instructions and applications may correspond to a set of instructions for performing one or more functions described herein. These instructions need not be implemented as separate software programs, procedures, or modules. The memory 1450 may include additional instructions or fewer instructions. Furthermore, various functions of the user device 104 may be implemented in hardware and/or in software, including in one or more signal processing and/or application specific integrated circuits.

In some embodiments, processor 1404 may perform processing including executing instructions stored in memory 1450, and secure processor 1405 may perform some processing in a secure environment that may be inaccessible to other components of user device 104. For example, secure processor 1405 may include cryptographic algorithms on board, hardware encryption, and physical tamper proofing. Secure processor 1405 may be manufactured in secure facilities. Secure processor 1405 may encrypt data/challenges from external devices. Secure processor 1405 may encrypt entire data packages that may be sent from user device 104 to the network. Secure processor 1405 may separate a valid user/external device from a spoofed one, since a hacked or spoofed device may not have the private keys necessary to encrypt/decrypt, hash, or digitally sign data, as described herein.

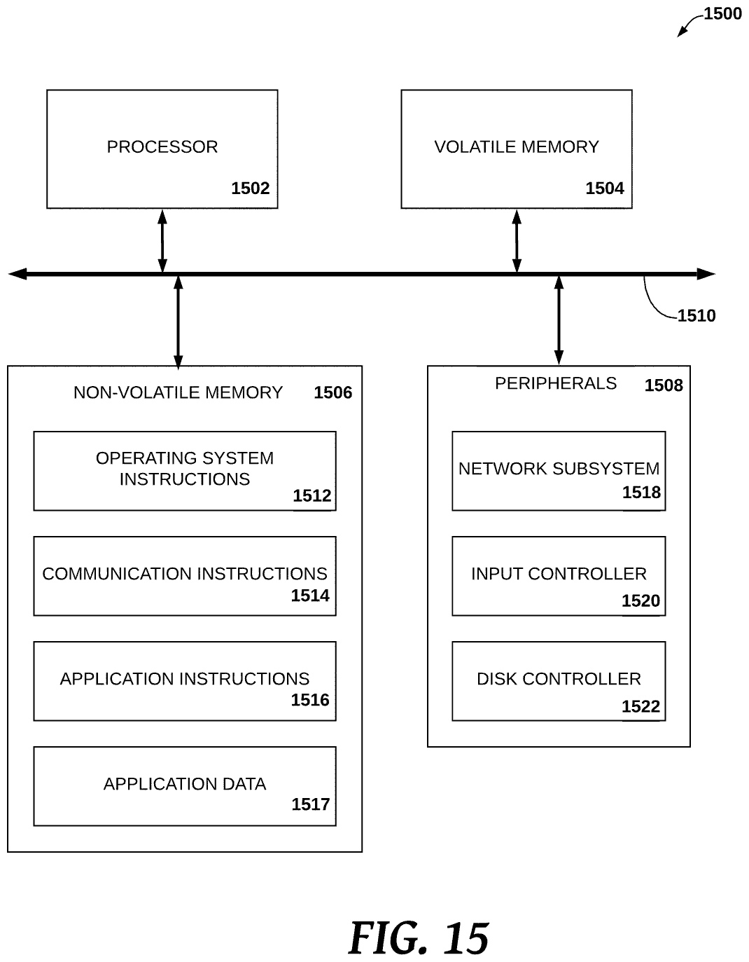

FIG. 15 shows an illustrative computer 1500 that may implement the archiving system and various features and processes as described herein. The computer 1500 may be any electronic device that runs software applications derived from compiled instructions, including without limitation personal computers, servers, smart phones, media players, electronic tablets, game consoles, email devices, etc. In some implementations, the computer 1500 may include one or more processors 1502, volatile memory 1504, non-volatile memory 1506, and one or more peripherals 1508. These components may be interconnected by one or more computer buses 1510.

Processor(s) 1502 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Bus 1510 may be any known internal or external bus technology, including but not limited to ISA, EISA, PCI, PCI Express, USB, Serial ATA or FireWire. Volatile memory 1504 may include, for example, SDRAM. Processor 1502 may receive instructions and data from a read-only memory or a random access memory or both. The essential elements of a computer may include a processor for executing instructions and one or more memories for storing instructions and data.

Non-volatile memory 1506 may include, by way of example, semiconductor memory devices, such as EPROM, EEPROM, and flash memory devices; magnetic disks such as internal hard disks and removable disks; magneto-optical disks; and CD-ROM and DVD-ROM disks. Non-volatile memory 1506 may store various computer instructions including operating system instructions 1512, communication instructions 1514, application instructions 1516. and application data 1517. Operating system instructions 1512 may include instructions for implementing an operating system (e.g., Mac OS®, Windows®, or Linux).

The operating system may be multi-user, multiprocessing, multitasking, multithreading, real-time, and the like. Communication instructions 1514 may include network communications instructions, for example, software for implementing communication protocols, such as TCP/IP, HTTP, Ethernet, telephony, etc. Application instructions 1516 can include social media and/or video streaming platform content characteristics, camera control commands, instructions for sharing content, and other information used or generated by other applications persisted on a user device. For example, application instructions 1516 may include instructions for modifying content previews, editing captured content, and/or capturing and sharing content using the systems shown in FIG. 1 and FIG. 2. Application data 1517 may correspond to data stored by the applications running on the computer 1500. For example, application data 1517 may include content, commands for controlling a camera, commands for controlling a robotic arm, commands for synchronizing a camera with a robotic arm, image data received from a camera, content characteristics retrieved from a social media and/or content video streaming platform, and/or instructions for sharing content.

Peripherals 1508 may be included within the computer 1500 or operatively coupled to communicate with the computer 1500. Peripherals 1508 may include, for example, network interfaces 1518, input devices 1520, and storage devices 1522. Network interfaces 1518 may include, for example, an Ethernet or WiFi adapter for communicating over one or more wired or wireless networks. Input devices 1520 may be any known input device technology, including but not limited to a keyboard (including a virtual keyboard), mouse, trackball, and touch-sensitive pad or display. Storage devices 1522 may include one or more mass storage devices for storing data files; such devices include magnetic disks, such as internal hard disks and removable disks; magneto-optical disks; and optical disks.

FIGS. 16-17 illustrate additional components included in an exemplary camera 102. As shown in FIG. 16, the camera 102 may include one or more image sensors 1604 fitted with one lens 1602 per sensor. The lens 1602 and image sensor 1604 can capture images or video content. Each image sensors 1604 and lens 1602 may have associated parameters, such as the sensor size, resolution, and interocular distance, the lens focal lengths, lens distortion centers, lens skew coefficient, and lens distortion coefficients. The parameters of each image sensor and lens may be unique for each image sensor or lens and are often determined through a stereoscopic camera calibration process. The camera device 1600 can further include a processor 1606 for executing commands and instructions to provide communications, capture, data transfer, and other functions of the camera device as well as memory 1608 for storing digital data and streaming video. For example, the storage device can be, e.g., a flash memory, a solid-state drive (SSD) or a magnetic storage device. The camera 102 may include a communications interface 1610 for communicating with external devices. For example, the camera 102 can include a wireless communications module for connecting to an external device (e.g., a laptop, an external hard drive, a tablet, a smart phone) for transmitting the data and/or messages to the external device. The camera 102 may also include an audio component 1612 (e.g., a microphone or other known audio sensor) for capturing audio content. A bus 1614, for example, a high-bandwidth bus, such as an Advanced High-performance Bus (AHB) matrix interconnects the electrical components of the camera 102.

FIG. 17 show more details of the processor 1606 of the camera device shown in FIG. 16. A video processor controls the camera 102 components including a lens 1602 and/or image sensor 1604 using a camera control circuit 1710 according to commands received from a camera controller. A power management integrated circuit (PMIC) 1720 is responsible for controlling a battery charging circuit 1722 to charge a battery 1724. The battery 1724 supplies electrical energy for running the camera 102. The PMIC 1720 may also control an electro adhesion control circuit 1790 that supplies power to an electroadhesion device 900. The processor 1606 can be connected to an external device via a USB controller 1726. In some embodiments, the battery charging circuit 1722 receives external electrical energy via the USB controller 1726 for charging the battery 1724.

The camera 102 may include a volatile memory 1730 (e.g. double data rate memory or 4R memory) and a non-volatile memory 1732 (e.g., embedded MMC or eMMC, solid-state drive or SSD, etc.). The processor 1606 can also control an audio codec circuit 1740, which collects audio signals from microphone 1712 and microphone 1712 for stereo sound recording. The camera 102 can include additional components to communicate with external devices. For example, the processor 1606 can be connected to a video interface 1750 (e.g., Wifi connection, UDP interface, TCP link, high-definition multimedia interface or HDMI, and the like) for sending video signals to an external device. The camera 102 can further include an interface conforming to Joint Test Action Group (JTAG) standard and Universal Asynchronous Receiver/Transmitter (UART) standard. The camera 102 can include a slide switch 1760 and a push button 1762 for operating the camera 102. For example, a user may turn on or off the camera 102 by pressing the push button 1762. The user may switch on or off the electroadhesion device 900 using the slide switch 1760. The camera 102 can include an inertial measurement unit (IMU) 1770 for detecting orientation and/or motion of the camera 102. The processor 1606 can further control a light control circuit 1780 for controlling the status lights 1782. The status lights 1782 can include, e.g., multiple light-emitting diodes (LEDs) in different colors for showing various status of the camera 102.

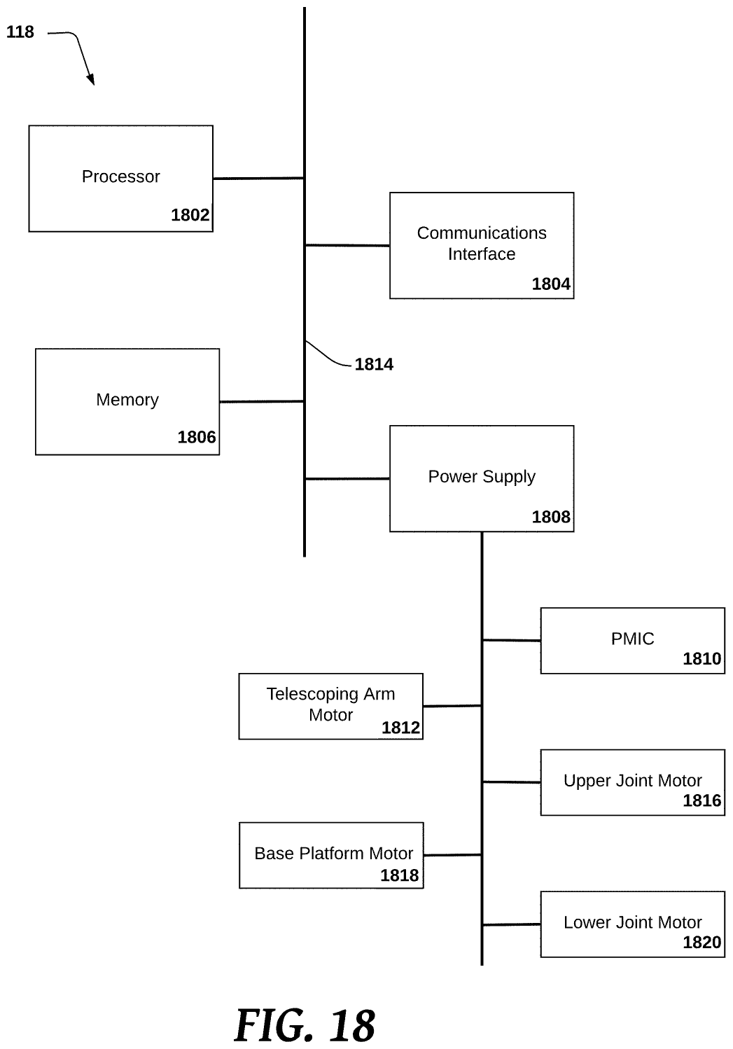

FIG. 18 illustrates additional components included in an exemplary robotic arm 118. As shown in FIG. 18, the robotic arm may have a computing device including a processor 1802 for executing commands and instructions to control the robotic arm. In various embodiments the processor 1802 may execute a control path the move the camera to one or more capture positions within a scene. The computing device of the robotic arm may also include memory 1806 for storing digital data, control, routes, and/or content. For example, the storage device can be, e.g., a flash memory, a solid-state drive (SSD) or a magnetic storage device. The robotic arm 118 may include a communications interface 1810 for communicating with external devices. For example, the robotic arm can include a wireless communications module for connecting to an external device (e.g., a laptop, an external hard drive, a tablet, a smart phone) for transmitting the data and/or messages, for example, control commands and/or control routes to the robotic arm 118 from an external device. The communications interface 1810 may also connect to the camera 102 to synchronize the content capture functionality of the camera 102 with the movements of the robotic arm 118.

The robotic arm 118 may also include a power supply 1808 (e.g., a battery) and a power management integrated circuit (PMIC) 1810 for managing charging and discharging of the battery as well as distributing power to one or more motors and/or an electroadhesion device included in the robotic arm 118. In various embodiments, the one or more motors may include a telescoping arm motor 1812 for extending and/or contracting the sections of the telescoping arm; a upper joint motor for activating one or more pivots included in the upper joint to move the camera attachment platform along an axis of rotation; a base platform motor 1818 for rotating the arm along an axis of rotation; and a lower joint motor for activating one or more pivots included in the lower joint to move the arm along an axis of rotation. The robotic arm may also include a bus 1614, for example, a high-bandwidth bus, such as an Advanced High-performance Bus (AHB) matrix interconnects the electrical components of the robotic arm 118.

The foregoing description is intended to convey a thorough understanding of the embodiments described by providing a number of specific exemplary embodiments and details involving capturing receipt information and associating receipt information with transaction data to improve functionality of online banking systems. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in any number of alternative embodiments, depending on specific design and other needs. A user device and server device are used as examples for the disclosure. The disclosure is not intended to be limited GUI display screens, image capture systems, data extraction processors, and client devices only. For example, many other electronic devices may utilize a system to capture receipt information and associate receipt information with transaction data to improve functionality of online banking systems.

Methods described herein may represent processing that occurs within a system (e.g., system 100 of FIG. 1). The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing; environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including, by ways of example, semiconductor memory devices, such as EPROM, EEPROM, flash memory device, or magnetic disks. The processor and the memory can be supplemented by, or incorporated in, special purpose logic circuitry.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

As used herein, the terms “and/or” and “at least one of” include any and all combinations of one or more of the associated listed items.

Certain details are set forth in the foregoing description and in FIGS. 1-18 to provide a thorough understanding of various embodiments of the present invention. Other details describing well-known structures and systems often associated with image processing, electronics components, device controls, content capture, content distribution, and the like, however, are not set forth below to avoid unnecessarily obscuring the description of the various embodiments of the present invention.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A robotic arm comprising:
an arm portion extending between a base platform and an attachment platform;
a lower joint connecting the arm portion to the base platform;
an upper joint connecting the arm portion to the attachment platform;
the attachment platform having an attachment mechanism for securing an object to the robotic arm;
a power supply electrically coupled to one or more motors coupled to the arm portion and the upper and lower joints; and
a computer having a processor and memory comprising instructions executable by the processor that is configured to move the robotic arm by controlling the one or more motors.

2. The robotic arm of claim 1, wherein the computer further comprises a communications component configured to connect to a remote computer to transmit and receive digital data from the remote computer.

3. The robotic arm of claim 2, wherein the digital data includes commands for controlling a movement of the robotic arm.

4. The robotic arm of claim 1, wherein the arm portion comprises a plurality of telescoping sections that extend out from and contract into a base section at a proximal end of the arm portion opposite the attachment platform at a distal end of the arm portion.

5. The robotic arm of claim 4, wherein the one or more motors further comprises a motor electrically coupled to the power supply that is configured to perform at least one of extending and contracting each telescoping section included in the plurality of telescoping sections.

6. The robotic arm of claim 1, wherein the one or more motors further comprise a motor in the base platform electrically coupled to the power supply and,
wherein the base platform has a rotating section configured to rotate the arm portion up to 360° relative to a vertical axis of rotation extending longitudinally up from the base platform.

7. The robotic arm of claim 1, wherein the one or more motors further comprise a motor in the lower joint electrically coupled to the power supply and, wherein the lower joint includes a right pivot and a left pivot configured to rotate the arm portion up to 180° relative to a horizontal axis of rotation extending horizontally out from the base platform.

8. The robotic arm of claim 1, wherein the one or more motors further comprises a motor in the upper joint electrically coupled to the power supply configured to rotate the attachment platform up to 180° relative to a vertical axis of rotation extending longitudinally up from the base platform.

9. The robotic arm of claim 1, wherein the attachment mechanism comprises an electroadhesion device.

10. The robotic arm of claim 9, wherein the electroadhesion device comprises:
a compliant film including one or more electrodes disposed in an insulating material having a chemical adhesive applied to at least one side;
a power supply connected to the one or more electrodes;
a sensor integrated into the electroadhesion device, the sensor configured to collect sensor data measuring one or more characteristics of a target surface; and
a digital switch configured to control a voltage output of the one or more electrodes based on sensor data,
wherein the voltage output of the one or more electrodes generates an electroadhesive force that secures the electroadhesion device to a target surface.

11. The robotic arm of claim 1, wherein the attachment mechanism comprises a mechanical mounting system.

12. A camera system comprising:
a robotic arm including;
an arm portion extending between a base platform and an attachment platform;
a lower joint connecting the arm portion to the base platform;
an upper joint connecting the arm portion to the attachment platform;
the attachment platform having an attachment mechanism for securing a camera to the robotic arm;
a power supply electrically coupled to one or more motors coupled to the arm portion and the upper and lower joints; and
a computer having a processor and memory comprising instructions executable by the processor that is configured to move the robotic arm by controlling the one or more motors;
the camera comprising:
a body;
an image sensor within the body configured to receive digital data; and
a communications component within the body configured to connect to a remote computer and transmit the digital data to the remote computer; and
the remote computer having a processor and memory including instructions executable by the processor that is configured to:
connect to the communications component of the camera and the computer of the robotic arm to transmit and receive digital data from the camera and the robotic arm;
control the robotic arm;
remotely activate the camera to capture content using the camera; and
receive digital data from the camera including captured content.

13. The system of claim 12, wherein the remote computer is configured to control the robotic arm by transmitting a control route to the computer of the robotic arm, the control route including instructions for using the one or more motors to move one or more components of the robotic arm.

14. The system of claim 13, wherein the instructions included in the control route are executed by the computer of the robotic arm to automatically move the camera to a series of capture positions.

15. The system of claim 14, wherein the series of capture positions are capture positions used by professional photographers during actual photoshoots.

16. The system of claim 13, wherein the remote computer is further configured to synchronize the camera and the robotic arm to automatically activate the camera to capture content at each capture position included in a series of capture positions.

17. The system of claim 13, wherein the remote computer is further configured to provide a live preview of a field of view captured by the camera.

18. The system of claim 17, wherein the remote computer is further configured to synchronize the camera and the robotic arm to automatically provide the live preview when the camera is moved to each capture position included in a series of capture positions, the live preview including a request to remotely activate the camera to capture content.

19. A method of capturing content using a camera system including a robotic arm, the method comprising:
connecting a camera and a remote computer by transmitting digital data between a communications component of the camera and the remote computer;
connecting the camera and the remote computer to a robotic arm by transmitting digital data between a communications component of the camera and a computer included in the robotic arm;
executing, by the computer, a control path received from the remote computer, the control path moving the camera to one or more capture positions using one or more motors included in the robotic arm;
synchronizing the camera and the robotic arm to remotely activate the camera at each capture positions to automatically capture content;
receiving, by the remote computer, digital data including content from the camera; and
generating, by the remote computer, a preview of the content captured by the camera during execution of the control path for review by a user.

20. The method of claim 19, further comprising:
connecting to a social media platform using the remote computer; and
sharing, on the social media platform, one or more pieces of content accepted by the user based on the preview generated by the remote computer.
